(19) United States
(12) Patent Application Publication
(10) Pub. No.: US 2019/0153309 A1
(43) Pub. Date: May 23, 2019

(54) Dinuclear Organometallic Complex and Application Using Same

(71) Applicants: AAC Microtech (Changzhou) Co., Ltd.,, Changzhou (CN); Zhejiang University of Technology, Hangzhou (CN)

(72) Inventors: Guijie Li, Shenzhen (CN); Yuanbin She, Shenzhen (CN); Xiangdong Zhao, Shenzhen (CN); Shaohai Chen, Saratoga, CA (US)

(21) Appl. No.: 15/975,569

(22) Filed: May 9, 2018

(30) Foreign Application Priority Data
Nov. 17, 2017 (CN) 201711143840.3

(51) Int. Cl. C09K 11/06

(52) U.S. Cl. CPC C09K 11/06; C09K 2211/1044; C09K 2211/1059; C09K 2211/185

(57) ABSTRACT

The invention relates to the technical field of organic luminescent materials, in particular to a binuclear organometallic complex and its application. The binuclear organometallic complexes of the invention are at least one of the compounds shown in the selected from general formula I. The luminescent interval of the binuclear organometallic complexes of the invention is in the range of 400 nm to about 700 nm, compared with the traditional complexes, the binuclear organometallic complexes of the invention have improved stability and efficiency.

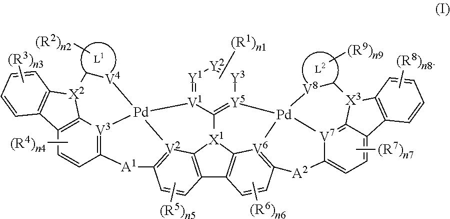

### FIELD OF THE PRESENT DISCLOSURE

The invention relates to the technical field of organic luminescent material, in particular to a binuclear organometallic complex, its luminescent devices and applications.

### DESCRIPTION OF RELATED ART

Compounds capable of absorbing and/or emitting light are ideally suited for use in a variety of optical and electroluminescent devices, including, for example, optical absorption devices e.g.: solar sensitive devices and photo sensitive devices, organic light-emitting diodes (OLED), light emitting devices, or marker devices that can both absorb and emit light and also be used as for biological applications. Many studies have been devoted to the discovery and optimization of organic and organometallic materials used in optical and electroluminescent devices. In general, the research in this area is aimed at achieving many objectives, including improving absorption and emission efficiency, and improving processing capacity.

Despite significant advances in research of chemical and electro-optic materials, for example, red-green phosphorescent organometallic materials have been commercialized and used in OLEDs, lighting devices, and phosphor materials in advanced displays. However, the available materials still have many shortcomings, including poor mechanical properties, inefficient emission or absorption, and less desirable stability.

However, up to now, the blue electroluminescent devices are still the most challenging field in this technology, and the stability of blue devices is a major problem. It has been proved that the selection of host materials is very important for the stability of blue devices.

However, the lowest energy of the triple excited state (T1) of the blue luminescent material is very high, which means that the lowest energy of the triple excited state (T1) of the host material from the blue device should be higher. This leads to greater difficulties in the development of the host materials from the blue equipment. Therefore, the limitation of the host materials in blue light devices is an important issue for its development.

In general, the changes in the chemical structure will affect the electronic structure of the compound, which in turn affects the optical properties of the compound (e.g., emission and absorption spectra), thus, it is capable of regulating or adjusting the compounds described in this application to specific emission or absorption energy. In some respects, the optical properties of the compounds disclosed in this application can be regulated by changing the structure of the ligand surrounding the metal center. For example, the compounds having ligands with electron-donating or electron-absorbing substituents usually exhibit different optical properties, including different emission and absorption spectra

Due to the fact that the phosphorescent polydentate palladium metal complexes can simultaneously use the electrically excited singlet and triplet excitons, 100% internal quantum efficiency can be obtained. Thus, these complexes can be used as OLEDs alternative luminescent materials. In general, the ligand of multi-toothed palladium metal complexes includes the luminescent groups and auxiliary groups. If the conjugated groups, e.g.: aromatic ring substituents or heteratomic substituents, are introduced into the luminescent part, the energy levels of the highest molecular of the luminescent material occupying the orbitals (HOMO) and the lowest molecular orbital (LOMOL) have been changed, at the same time. By further regulating the energy level gap between the HOMO orbital and the LOMO orbital, the emission spectral properties of the phosphorescent polydentate palladium metal complex can be regulated, e.g.: making it wider or narrower, or making red shift or blue shift.

Therefore, there is a need for new materials that exhibit improved performance in optical emission and absorption applications. Thus, such compounds and their luminescent devices are disclosed herein.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 shows ¹H NMR map of Compound 1 in accordance with the present invention.

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

The present invention is further elaborated in combination with exemplary embodiments. It should be understood that these embodiments are used only to illustrate the invention and not to limit the scope in the invention.

The embodiment of the invention provides a binuclear organometallic complex, which is selected from at least one of the compounds shown in the general formula I:

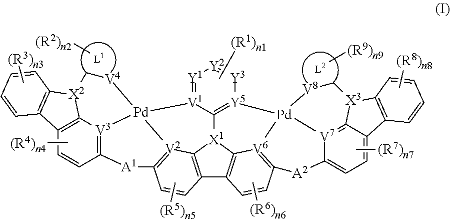

In the formula I, L¹ and L² denote C₆˜C₁₈ aromatic ring. C₃˜C₁₈ heterocyclic ring and C₄˜C₈ heterocyclic independently, respectively. In which, C₆˜C₁₈ aromatic ring can be selected from benzene ring and fused ring structure naphthalene ring etc, and C₃˜C₁₈ heterocyclic ring is an aromatic ring containing at least one hetero atom, and the hetero atom can be selected from nitrogen atom, oxygen atom, phosphorus atom etc, and further selected from nitrogen atom.

In which, from the point of view of preparation, the preparation process is more convenient when L¹ and L² are the same, but it can also be different.

In the formula I, V1, V2, V3, V4, V5, V6, V7 and V8 are atoms coordinated with palladium, which are selected from nitrogen atoms or carbon atoms independently, respectively. At least two of V1, V2, V3 and V4 are nitrogen atoms, and at least two of V5, V6, V7 and V8 are nitrogen atoms.

The specific options of V1, V2, V3, V4, V5, V6, V7 and V8 are listed below:

V1 and V4 are N, V2 and V3 are C, V5 and V8 are N, V6 and V7 are C; or

V1 V2 and V3 are C, V4 are N, V5 and V8 are N, V6 and V7 are C; or

V1 and V3 are C, V2 and V4 are N, V5 and V7 are C, V6 and V8 are N.

Optionally, V1, V5 are nitrogen atoms, at least one of V2, V3 and V44 is a nitrogen atom, and at least one of V6, V7 and V8is a nitrogen atom.

Further optionally, V1, V4, V5 and V8 are nitrogen atoms, while V2, V3, V6 and V7 are carbon atoms.

In formula I, X1, X2, X3 are trivalent connecting units capable of connecting three groups, each of which is independently selected from

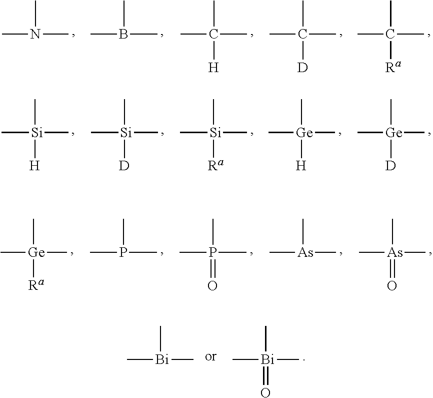

The specific options of X¹, X², and X³ are listed below:

X¹is N, X²is N, X³ is N;

X¹ is B, X² is B, X³ is B;

X¹ B, X² is N, X³ is N;

X¹ is N, X² is B, X³ is N;

X¹ is N, X² is N, X³ is B

X¹ is P═O, X² is N, X³ is N;

X¹ is N, X² is P═O, X³ is N;

X¹ is N, X² is N, X³is P═O;

X¹ is N, X² is B, X³ is B;

X¹ is B, X² is N, X³ is B;

X¹ is B, X² is B, X³ is N;

X¹ is P═O, X²is N, X³is P═O;

X¹ is CR^{a}, X² is CR^{a}, X³is CR^{a};

X¹ is CR^{a}, X² is N, X³ is N;

X¹ is N, X² is CR^{a}, X³ is N;

X¹ is N, X² is N, X³ is CR^{a};

X¹ is CR¹, X² is N, X³ is CR^{a}

X¹ is N, X² is CR^{a}, X³ is CR^{a}

X¹ is CR^{a}, X² is CR^{a}, X³ is N;

X¹ is N, X² is SiR^{a}, X³ is N;

X¹ is N, X² is N, X³ is SiR^{a};

X¹ is SiR^{a}, X² is N, X³ is SiR^{a};

X¹ is N, X² is SiR^{a}, X³ is SiR^{a};

X¹ is SiR^{a}, X² is SiR¹, X³ is N.

Optional, X¹ is

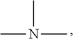

In formula I, Y¹, Y² and Y³are independently selected from nitrogen or carbon atoms, respectively.

Optionally, in the ring structure containing Y¹, Y² and Y³, V¹ and V⁵ are nitrogen atoms, the specific structure of

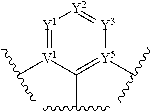

can be selected from

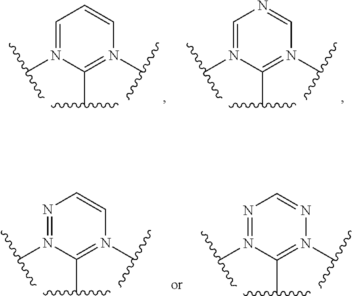

In which, this represents a chemical bond marked with the symbol “ [symbol] ”, indicating that the chemical bond is connected to other atoms.

In formula I, A¹ and A² are bivalent connecting units capable of connecting two groups, each of which is independently selected from —O—, —S—, —CH₂—, —CD₂-, —CR^{a}R^{b}—, —C(═O)—, —SiR^{a}R^{b}—, —GeH₂—, —GeR^{a}R^{b}—, —NH—, —NR^{c}—, —PH—, —PR^{c}—, —R^{c}P(═O)—, —AsR^{c}—, —R^{c}As(═O)—, —S(═O)—, —SO₂—, —Se—, —Se(═O)—, —SeO₂—, —BR^{c}—, —R^{c}Bi(═O)—, —BiH—, or —BiR^{c}—, respectively.

A¹ and A² can be the same or different, with the specific options as follows:

When A¹ is O, A² is O;

When A¹ is O, A² is S;

When A¹ is CR^{a}R^{b}, A² is CR^{a}R^{b};

When A¹ is NR^{c}, A² is NR^{c};

When A¹ is O, A² is NR^{c};

When A¹ is CR^{a}R^{b}, A² is NR^{c};

When A¹ is BR^{c}, A² is BR^{c}.

In formula I, R¹, R², R³, R⁴, R⁵, R⁶, R⁷, R⁸, R⁹, R^{a}, R^{b}, R^{c} and R^{d} are selected from hydrogen, deuterium, halogen, hydroxyl, sulfhydryl, nitro, cyanide, amino, amino, carboxyl, sulfonyl, hydrazine, ureyl, substituted or unsubstituted C₁˜C₂₄ alkyl, substituted or unsubstituted C₂˜C₂₄ alkyl, substituted or unsubstituted C₂˜C₂₄ alkyl, substituted or unsubstituted C₂˜C₂₄ alkyl, substituted or unsubstituted C₆˜C₃₆ aryl, substituted or unsubstituted C₃˜C₁₈ heterocyclic, substituted or unsubstituted C₆˜C₃₆ hetero aryl, substituted or unsubstituted C₁˜C₂₄ alkoxy, substituted or unsubstituted C₁˜C₂₄ alkyl thioyl, substituted or unsubstituted C₂˜C₂₄ enoxy, substituted or unsubstituted C₂˜C₂₄ alkyloxy group, substituted or unsubstituted C₆˜C₃₆ aryl group, substituted or unsubstituted C₁˜C₂₄ alkoxy carbonyl, substituted or unsubstituted C₂˜C₃₆ ester, substituted or unsubstituted C₂˜C₃₆ amide, substituted or unsubstituted C₁˜C₃₆ sulfonyl group, substituted or unsubstituted C₁˜C₃₆ sulfonyl groups, substituted or unsubstituted C₁˜C₃₆ sulfonyl amines, substituted or unsubstituted C₁˜C₃₆ phosphoryl amines, Substituted or unsubstituted C₂˜C₂₄ alkoxy carbonyl amine, substituted or unsubstituted ˜C₃₇ aryl oxy carbonyl amine, substituted or unsubstituted methylsilyl, substituted or unsubstituted C₁˜C₁₈ monoalkylamino, substituted or unsubstituted C₂˜C₃₆ dialkylamino, substituted or unsubstituted C₆˜C₃₆ monoaryl amine, substituted or unsubstituted C₁₂˜C₇₂ bisaryl amine, substituted or unsubstituted C₁˜C₃₆ suburetic, substituted or unsubstituted C₂˜C₃₆ imino, respectively; the substituents are selected from deuterium, halogen, hydroxyl, mercapto, nitro, cyanide, amino, carboxyl, sulfonyl, hydrazine, ureyl, C₂˜C₆ alkyl, C₆˜C₁₂ aryl group, respectively.

In formula I, two or more adjacent R¹, R², R³, R⁴, R⁵, R⁶, R⁷, R⁸ and R⁹ can be connected to form rings to form heterolipids and heterocyclic rings. For example, two R¹ can form the structure of benzene ring, benzocyclohexane etc on the ring substituted by R¹.

In the formula I, n₁, n₂, n₃, n₄, n₅, n₆, n₇, n₈, n₉ are selected from integers 1˜4 independently, respectively. In which, the maximum number of substituents is determined by the number of substitutable hydrogen atoms on the ring where the substituents are located.

Taking R¹ as an example, the specific options are as follows:

R¹ does not exist, or R¹ exists, n₁ can be 1, 2, 3, 4, i.e., the formation of single substitution, double substitutions, three substitutions and four substitutions.

In the above-mentioned substituents:

If the alkyl has 1˜24 carbon atoms, the alkyl can be chain alkyl or cycloalkyl, and the hydrogen located on ring of naphthyl can be substituted by alkyl, e.g.: methyl, ethyl, n-propyl, isopropyl, N-butyl, isobutyl, S-butyl, Tert butyl, n-amyl, isoamyl, secondary pentyl, neopentyl, hexyl, heptyl, semi-radical, nonyl, decyl, 12 alkyl, 14 alkyl, cetyl, 20 alkyl, 24 alkyl, etc.

If the alkyl group has 2˜24 carbon atoms, it can be either cycloalkene group or chain alkenyl group. The number of double-bond in the alkenyl group may be one or more. Specific examples: vinyl, allyl, isopropenyl, pentenyl, cyclopentenyl, cyclobutenyl, cyclopentenyl, cyclopentadienyl, cyclohexenyl, cyclohexadienyl.

If the alkynyl group has 2˜24 carbon atoms, it can be either cyclic or chained. The number of three-bond in the alkynyl group may be one or more. Specific examples: acetylene, propyl, isopropargyl, pentylethynyl, cycloheptynyl, cyclooctynyl, cyclononyl, etc.

If the aryl group has 6˜36 carbon atoms, including a plurality of phenyl-linked biphenyls, also includes two or more phenyl fused to form a dense ring compound, specific examples: phenyl, naphthyl, biphenyl etc.

Heterocyclic groups include heterocyclic groups and hetero-aryl groups, including heterocyclic groups formed by heterocyclic compounds without aromatic characteristics. Specific examples: heterocyclobutylamine and dioxane. Hetero-aryl refers to a monocyclic and polycyclic aromatic ring system: at least one of its central members is not carbon. Specific examples: furyl, imidazolyl, isothiazolyl, isoxazinyl, morpholinyl, oxazolyl (e.g., 1,2,3-oxadiazol, 1,2,5-oxadiazol, 1,3,4-oxadiazol), piperazinyl, piperidinyl, pyrazinyl, pyrazolyl, pyridyl, pyrimidinyl, pyrrolyl, pyrrolidinyl, tetrahydrofuryl, tetrahydropyranyl, tetrazine (e.g., 1,2,4,5-tetrazine), tetrazole (e.g., 1,2,3,4-tetrazole, 1,2,4,5-tetrazole), thiadiazole (1,2,3-thiadiazole, 1,2,5-thiadiazole, and 1,3,4-thiadiazole), thiazole, thienyl, triazine (e.g., 1,3,5-triazine, 1,2,4-triazine), triazolyl (1,2,3-triazolyl, 1,3,4-triazolyl) etc.

When the above alkyl group contains oxygen atoms, it may be alkoxy group, when the above alkyl group contains oxygen atom, it can be alkenyloxy group, when the above alkynyl group contains oxygen atom, it may be alkyloxy group. When the above aryl group contains oxygen atoms, it may be an aromatic oxygen group. When the above alkyl contains sulfur atoms, it may be alkyl thio.

Alkoxy carbonyl groups are denoted by —O—C (═O)—R′, in which R′ is an alkyl of the present invention.

Methylsilyl is denoted by —SiR′ R″ R′″, in which R′, R″ and R′″ may be hydrogen or alkyl, alkoxy, alkyl, alkyl, alkynyl, aryl or hetero-aryl as described in this application independently.

The sulfonyl group is denoted by —S (═O)₂R′, and the sulfonyl group is denoted by —S (═O)—R′, in which R′ is alkyl, alkoxy, alkenyl, acetyl, aryl or hetero-aryl etc. described in the present invention.

The sulfonyl amino groups are denoted by —S(═O)₂—NH—R′, —S(═O)₂—N R′R″, in which, R′, R″ are alkyl, alkoxy, alkenyl, alkynyl, aryl or hetero-aryl etc described in this invention.

The amido group is denoted by —C(═O)—NH—R′, —S(═O)₂—NR′R″, in which, R′, R″ are alkyl, alkoxy, alkenyl, alkynyl, aryl or hetero-aryl etc described in this invention.

The phosphoryl group is denoted by —P(═O)2-NH—R′, —P(═O)₂—NR′R″, in which, R′, R″ are alkyl, alkoxy, alkenyl, alkynyl, aryl or hetero-aryl etc described in this invention.

The alkoxy carbonyl amino group is denoted by —O—C(═O)—NH—R′, —O—C(′O)—NR′R″, in which, R′, R″ are alkyl groups described in the present invention.

The aryl oxy carbonyl amino group is denoted by —O—C (═O)—NH—R′, —O—C (═O)—NR′R″, in which, R′, R″ are the aryl groups of the present invention.

The dialkylamino group is denoted by —NR′R″, in which R′, R″ are the alkyl groups of the present invention.

Monoalkylamine groups are denoted by —NH—R′, in which R′ is the alkyl of the invention.

The bisaryl amino group is denoted by —NRR″, in which R′, R′ are the aryl groups of the present invention.

The monoaryl amino group is denoted by —NH—R′, in which R′ is the aryl group of the present invention.

The suburetic groups are denoted by —NH—C(═O)—NH—R′, —R″—NH—C(═O)—NH—R′, in which R′ is alkyl, alkenyl, alkynyl, aryl or hetero-aryl etc, and R″ is alkyl, alkenyl, alkylidene, aryl or hetero-aryl, which are alkyl, alkenyl, alkylidene, aryl or hetero-aryl etc described in this invention.

The iminodium group is denoted by —C(═N—R′)—R″, in which R′, R′″ are alkyl, alkenyl, acetylene, aryl or hetero-aryl etc described in the present invention.

The ester groups are denoted by —C(═O)—O—R″, in which R′ is the alkyl, alkenyl, alkynyl, aryl or hetero-aryl etc described in the present invention.

Halogens include fluorine, chlorine, bromine, and iodine.

The luminescence interval of the polydentate binuclear organometallic complexes is from 400 nm to about 700 nm. The color of binuclear organometallic complexes is regulated by modifying fluorescent luminaires and conjugated groups on ligands so that the binuclear organometallic complexes of the present invention are customized or tuned to expect specific emission or absorption characteristics. Moreover, the binuclear organometallic complexes of the invention have improved stability and efficiency, compared with the traditional emission complexes.

The binuclear organometallic complex, as a novel phosphorescent material, is electrically neutral. The electric neutral is beneficial to the improvement of the evaporation property of the metal complexes; the novel binuclear organometallic complexes can not only regulate the photophysical properties of the complexes through the regulation of ligands; and its properties can also be regulated by bimetallic strip; furthermore, the form and strength of ligands and two metals can be adjusted by the design of ligands, and then the control of the whole molecular photophysical properties can be achieved.

As an improvement of the binuclear organometallic complexes of the present invention, at least one of the compounds shown in the general formula IA is selected:

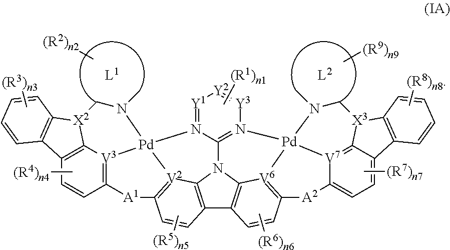

According to the ring structure of Y¹, Y² and Y³, the organometallic complexes of the embodiment of the present invention may be further selected from the groups composed of compounds shown by the general formula IAa, the general formula IAb, the general formula IAc and the general formula IAd:

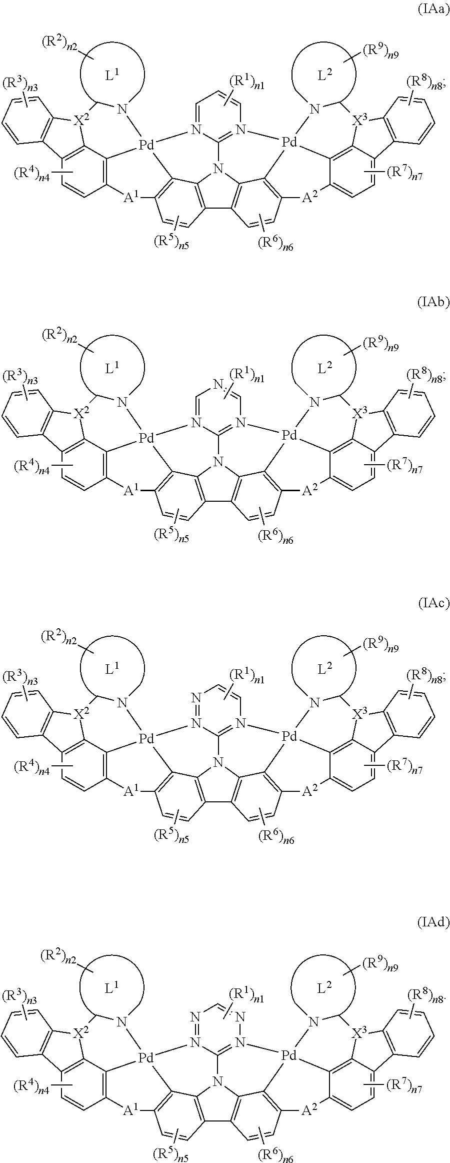

In general formula IAa, according to difference between A¹ and A², the binuclear organometallic complexes of the embodiment of the invention can be further selected from the groups composed of compounds shown in the general formula IAa1, general formula IAa2 and general formula IAa3:

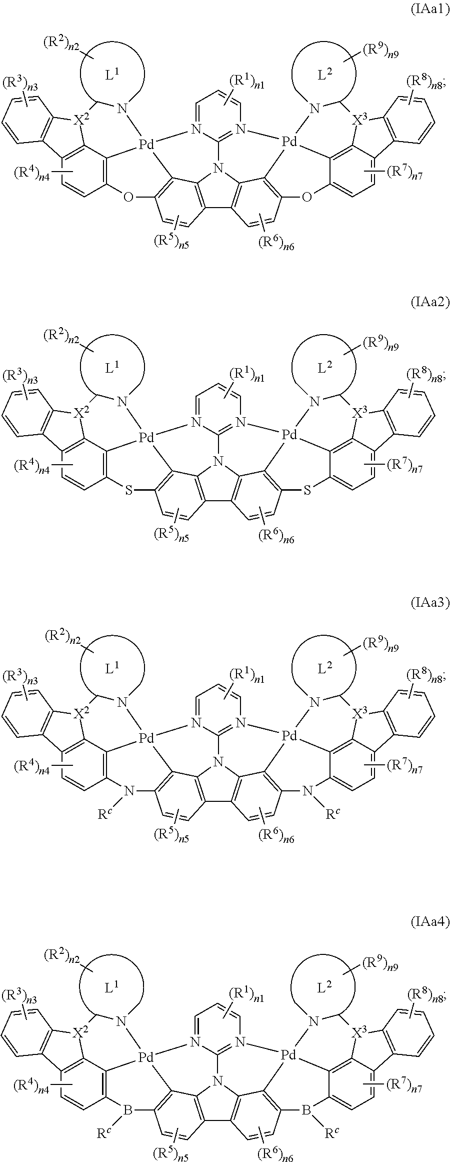

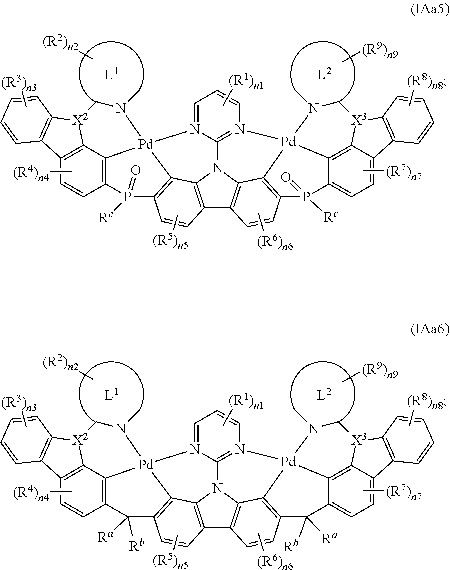

In which, X² and X³ are selected independently from

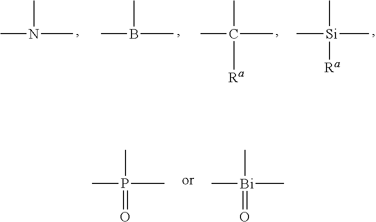

respectively;

R^{a}, R^{b} and R^{c} are selected from substituted or unsubstituted C₁˜C₁₈ alkyl, substituted or unsubstituted C₆˜C₃₆ aryl group, substituted or unsubstituted C₃˜C₁₈ heterocyclic group, substituted or unsubstituted C₃˜C₁₈ heterocyclic group, substituted or unsubstituted C₃˜C₃₆ hetero aryl group and substituents are selected from C₁˜C₆ alkyl and C₆˜C₁₂ aryl groups independently, respectively.

In general formula IAa3, the compounds shown in the general formula IAa3 are selected from groups composed of the compounds shown in the general formula IAa31, the general formula IAa32, and the general formula IAa33:

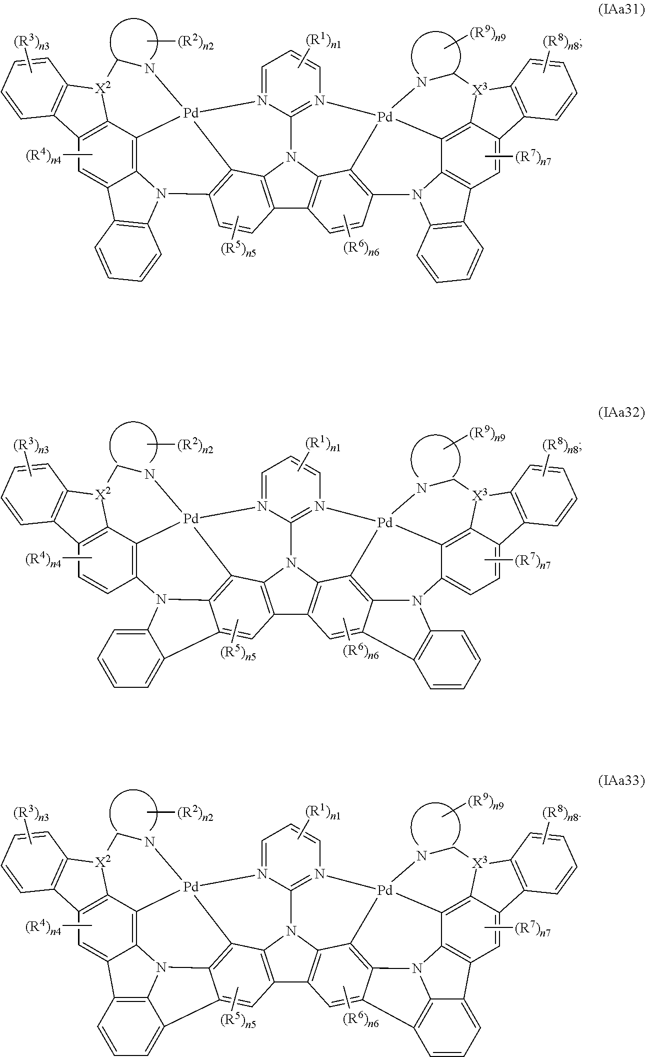

In general formula IAa4, the compounds shown in the general formula IAa4 are selected from groups composed of compounds shown in the general formula IAa41, the general formula IAa42, and the general formula IAa43:

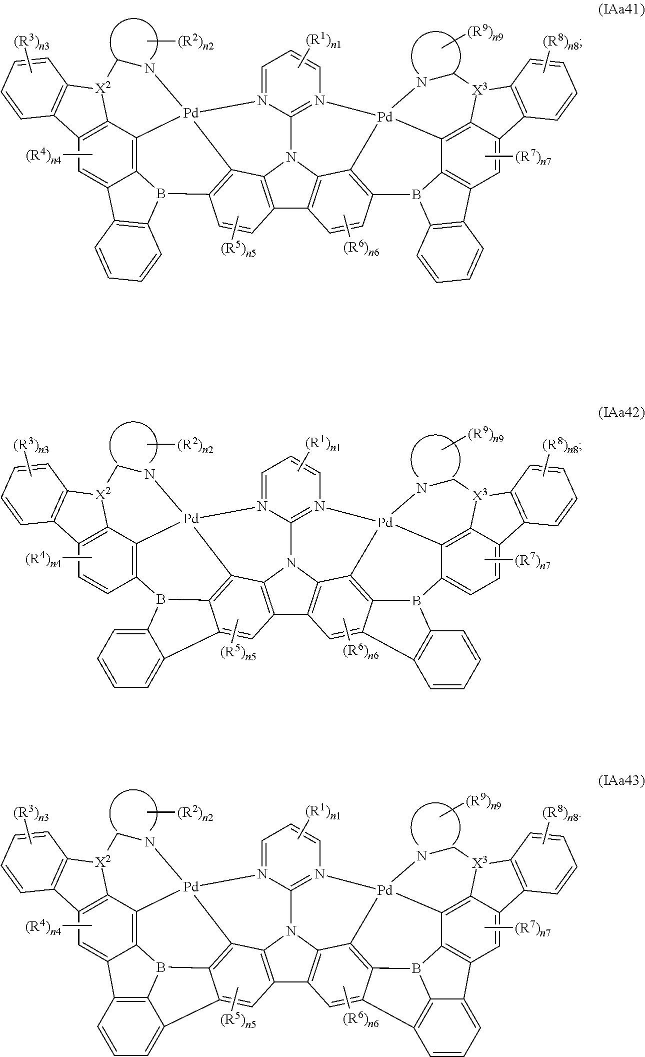

In a general formula IAb, according to the differences between A¹ and A², the compounds of the embodiment of the present invention are selected from the groups composed of compounds shown in the general formula IAb1, general formula IAb2, general formula IAb3:

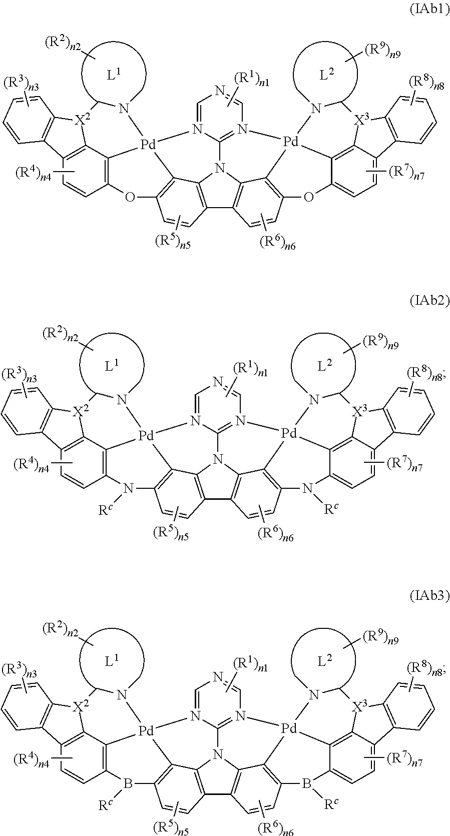

X² and X³ are selected independently from

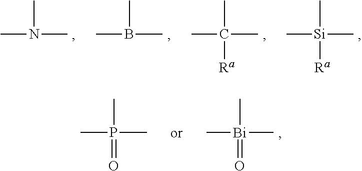

respectively;

R^{a}, R^{b} and R^{c} are selected from substituted or unsubstituted C₁˜C₁₈ alkyl, substituted or unsubstituted C₆˜C₃₆ aryl group, substituted or unsubstituted C₃˜C₁₈ heterocyclic group, substituted or unsubstituted C₃˜C₁₈ heterocyclic group, substituted or unsubstituted C₃˜C₃₆ hetero aryl group and substituents are selected from C₁˜C₆ alkyl and C₆˜C₁₂ aryl groups independently, respectively.

In general formula IAb2, the compounds shown in the general formula IAb2 are selected from groups composed of compounds shown the general formula IAb21, the general formula IAb22, and the general formula IAb23:

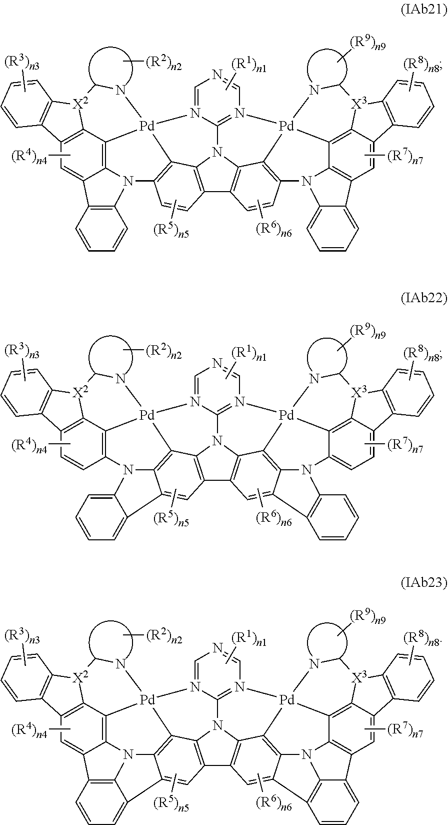

in general formula IAb3, the compounds shown in the general formula IAb3 are selected from the groups composed of compounds shown in the general formula IAb31, the general formula IAb32, and the general formula IAb33:

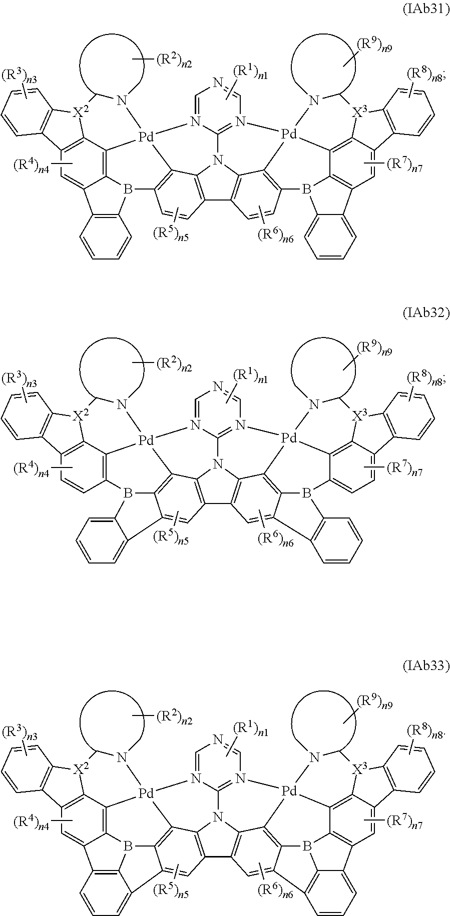

In a general formula IAc, according to the differences between A¹ and A², the compounds of the embodiment of the present invention are selected for at least one of the compounds shown in the general formula IAc1, the general formula IAc2, and the general formula IAc3:

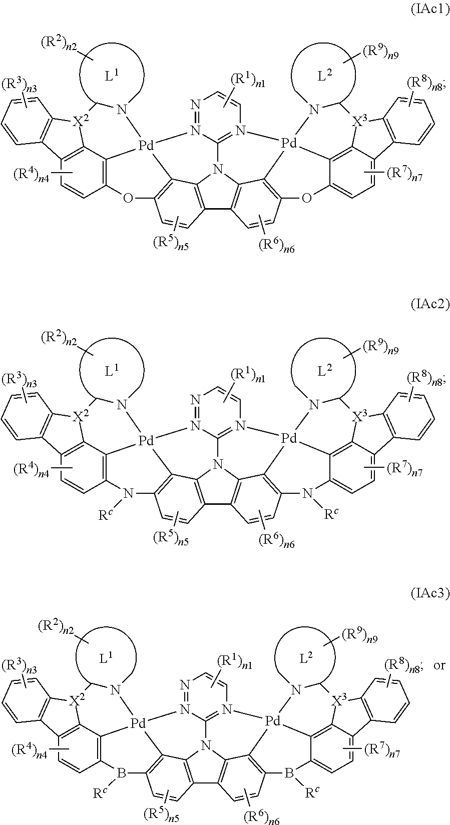

X² and X³ are selected independently

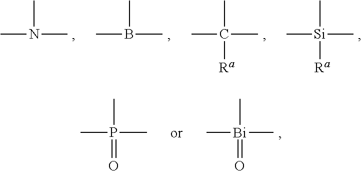

respectively;

R^{c} is selected from substituted or unsubstituted C₁˜C₁₈ alkyl, substituted or unsubstituted C₆˜C₃₆ aryl group, substituted or unsubstituted C₃˜C₁₈ heterocyclic group, substituted or unsubstituted C₃˜C₁₈ heterocyclic group, substituted or unsubstituted C₃˜C₃₆ hetero aryl group and substituents are selected from C₁˜C₆ alkyl and C₆˜C₁₂ aryl groups independently, respectively.

In general formula IAc2, the compounds shown by the general formula IAc2 is selected from at least one of compounds shown in the general formula IAc21, the general formula IAc22, the general formula IAc23:

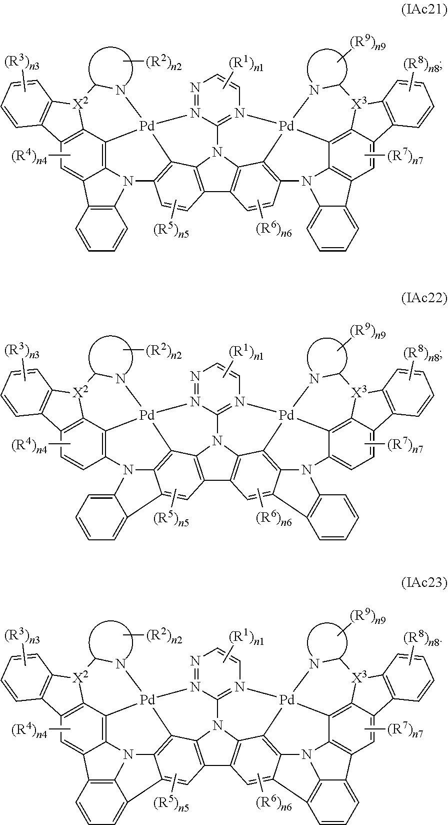

In general formula IAc3, the compounds shown by the general formula IAc3 is selected from at least one of compounds shown in the general formula IAc31, the general formula IAc32, the general formula IAc33:

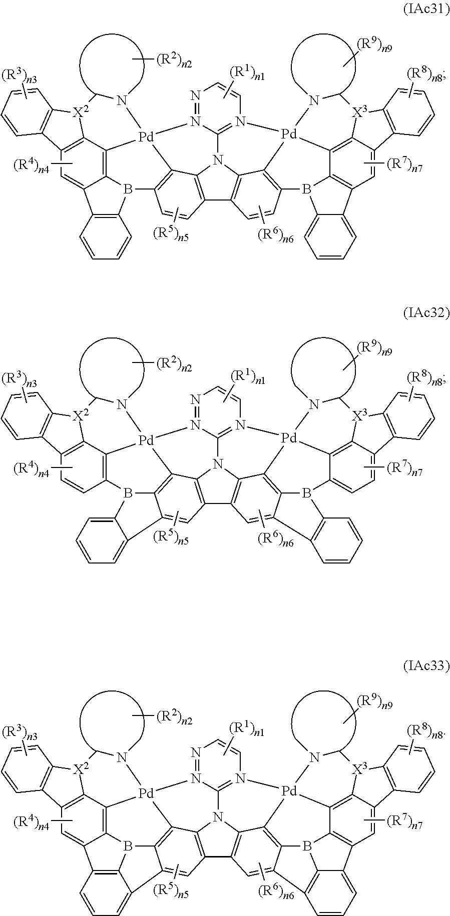

In a general formula IAd, according to the differences between A¹ and A² the compounds of the embodiment of the present invention are selected from the groups composed of compounds shown in the general formula IAd1, general formula IAd2, general formula IAd3:

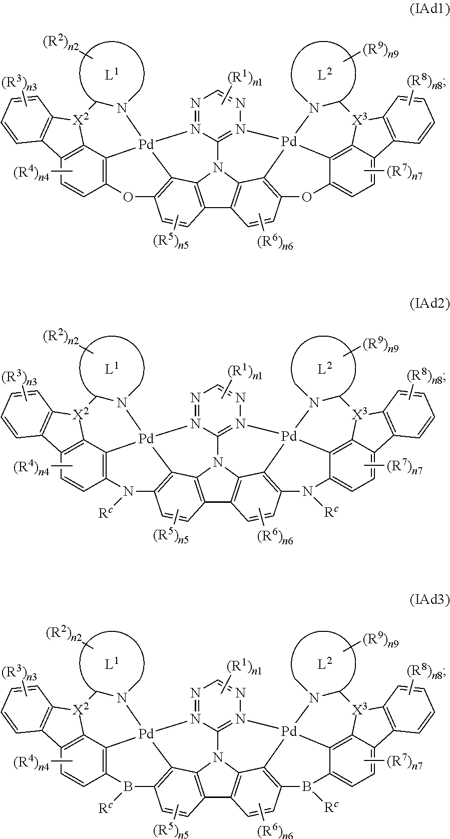

X² and X³ are selected independently

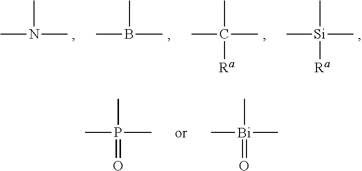

respectively;

R^{c} is selected from substituted or unsubstituted C₁˜C₁₈ alkyl, substituted or unsubstituted C₆˜C₃₆ aryl group; substituted or unsubstituted C₃˜C₁₈ heterocyclic group, substituted or unsubstituted C₃˜C₁₈ heterocyclic group, substituted or unsubstituted C₃˜C₃₆ hetero aryl group and substituents are selected from C₁˜C₆ alkyl and C₆˜C₁₂ aryl groups independently, respectively.

In a general formula IAd2, the compound shown in the general formula IAd2 is selected from at least one of compounds shown in the general formula IAd21, the general formula IAd22, the general formula IAd23,

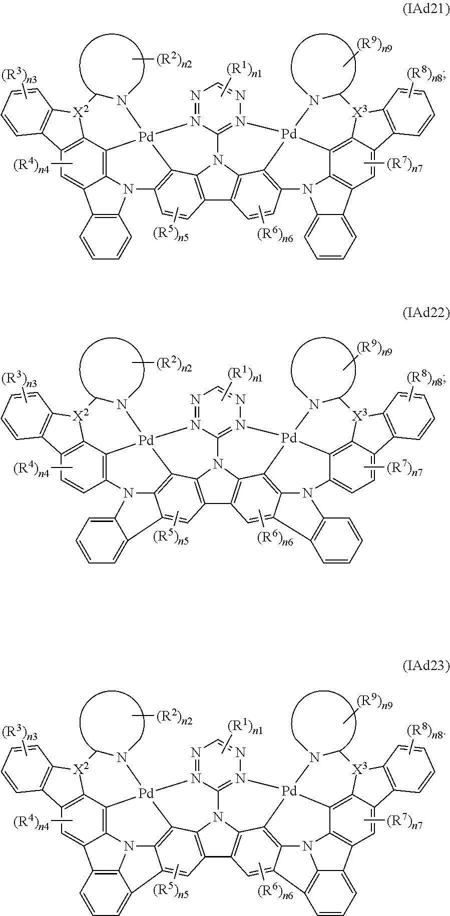

In a general formula IAd3, the compound shown in the general formula IAd3 is selected from at least one of compounds in the general formula IAd31, the general formula IAd32, the general formula IAd33,

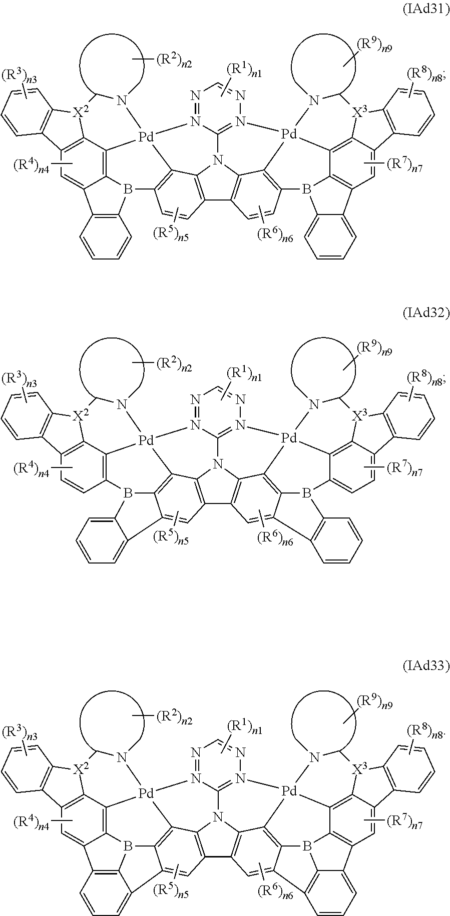

In the above general formula, further, L₁, L₂ represents the rings represented by the following structural expressions, respectively:

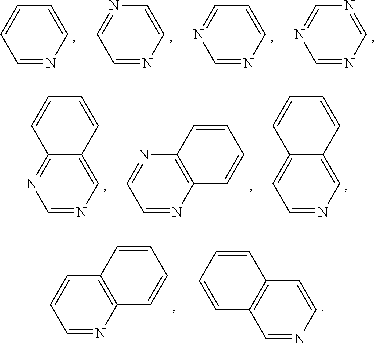

Optionally, the binuclear organometallic complexes of the embodiment of the present invention are selected from a group of compounds shown in the following chemical formula and are not limited to this:

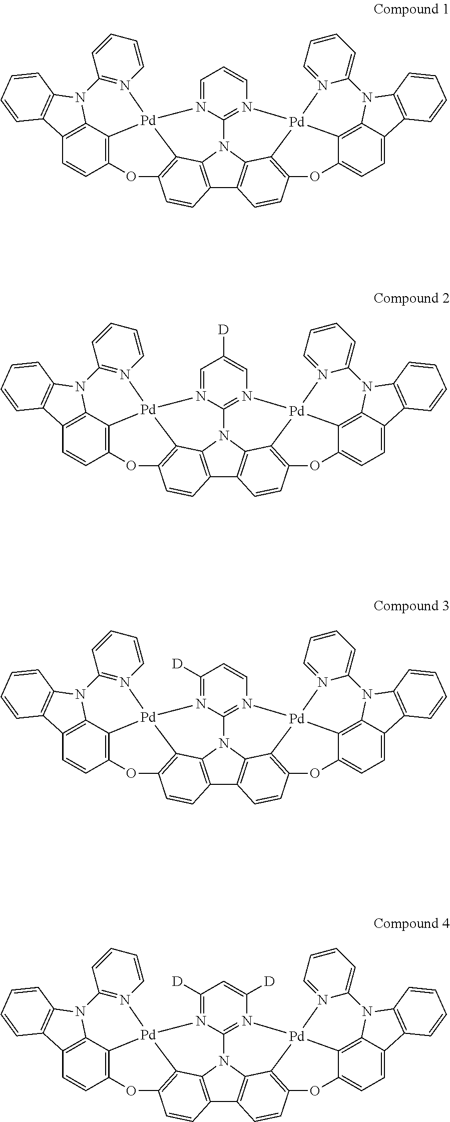

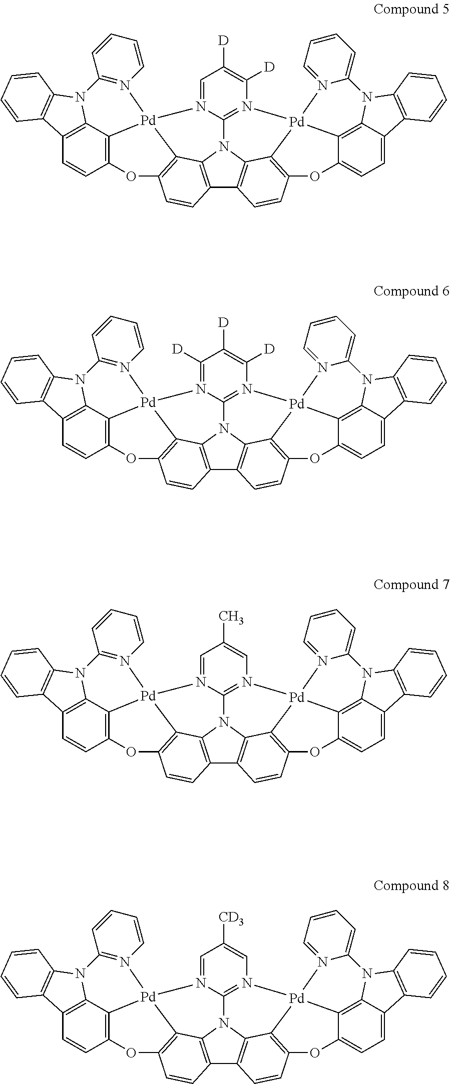

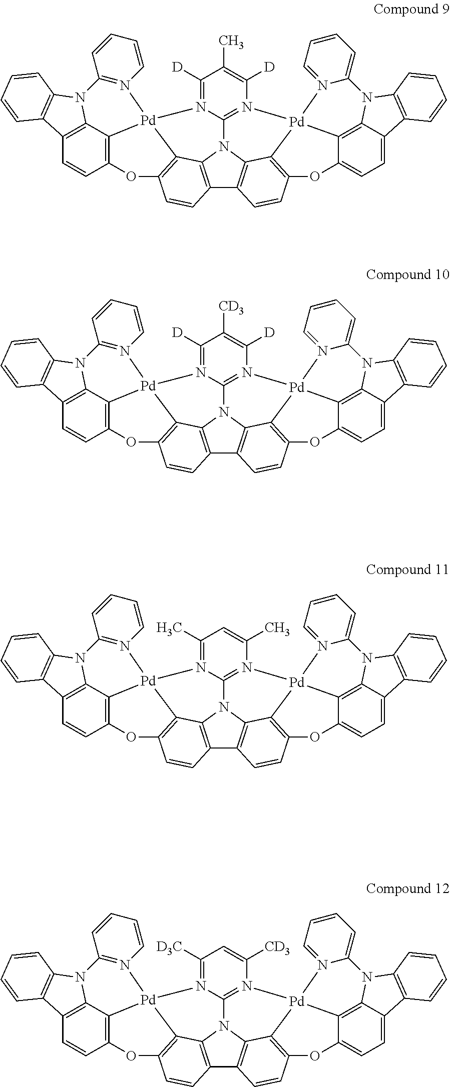

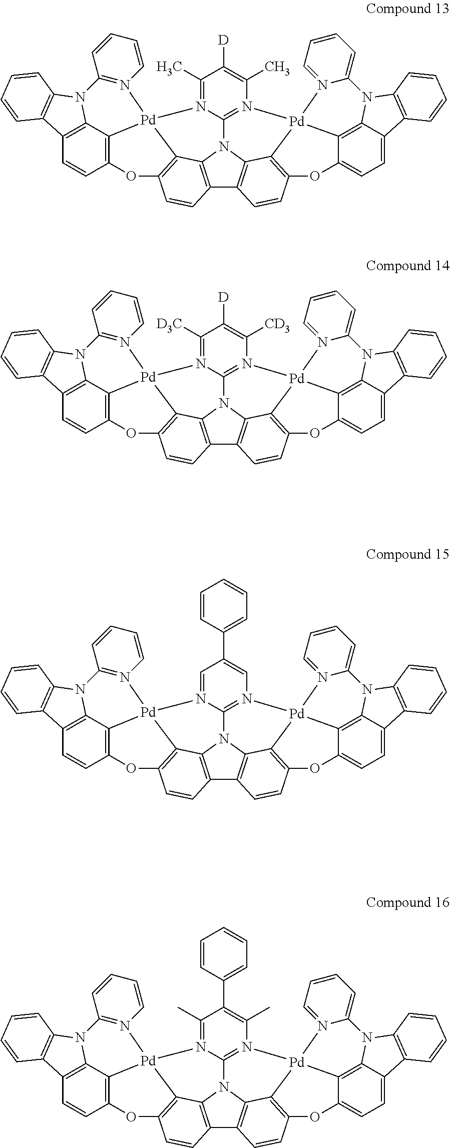

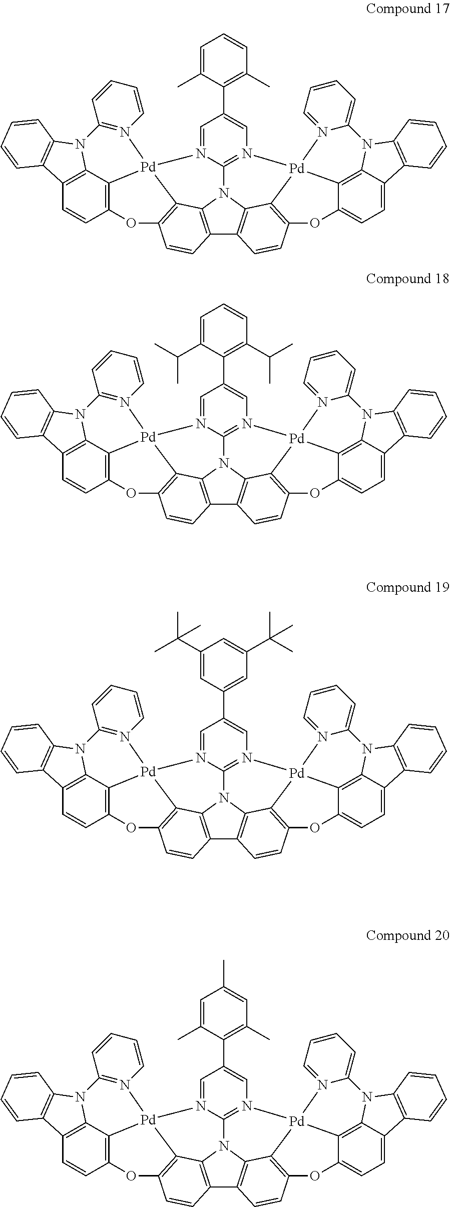

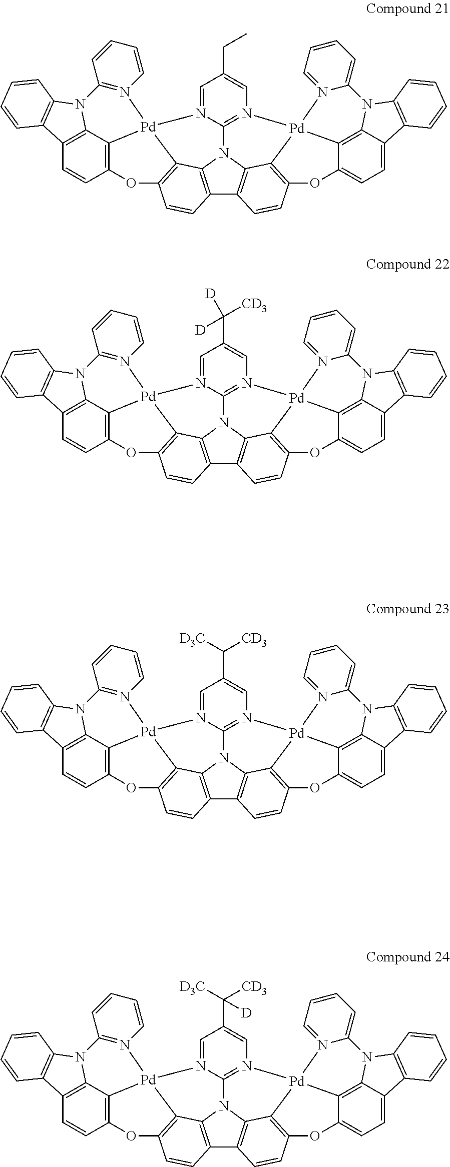

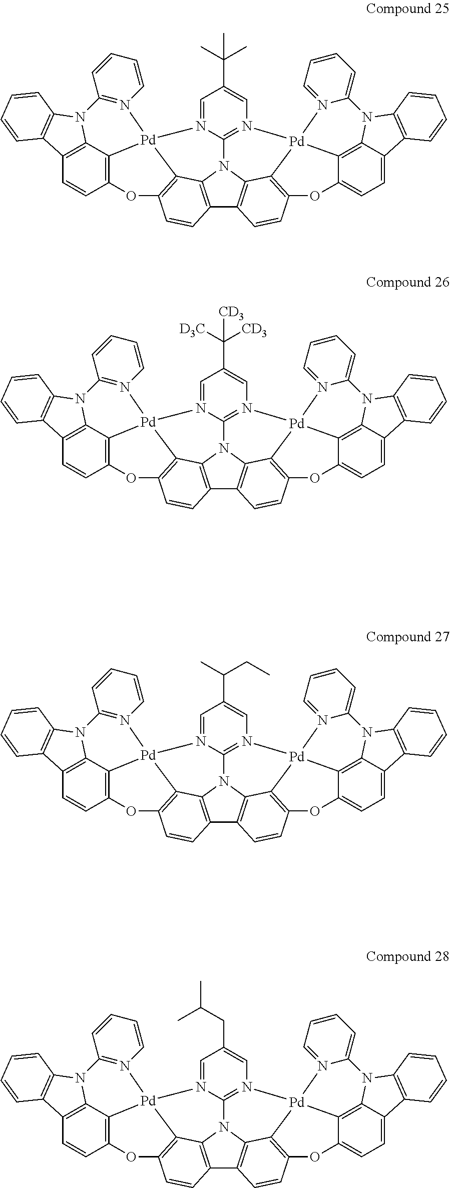

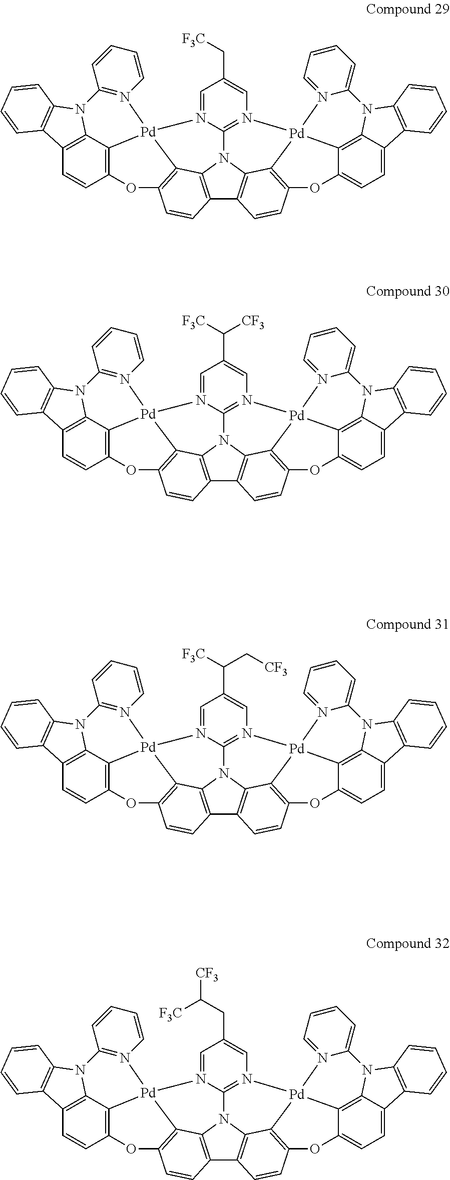

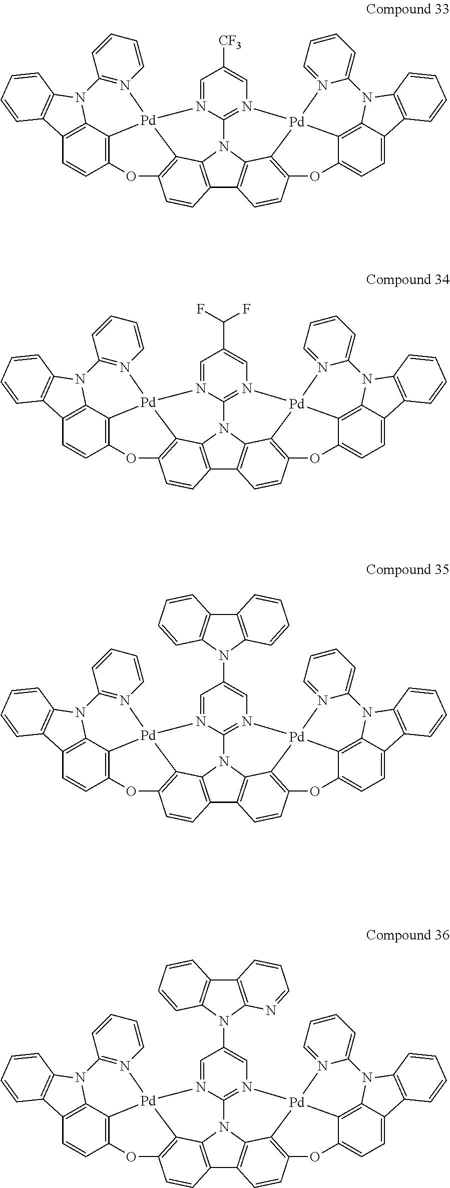

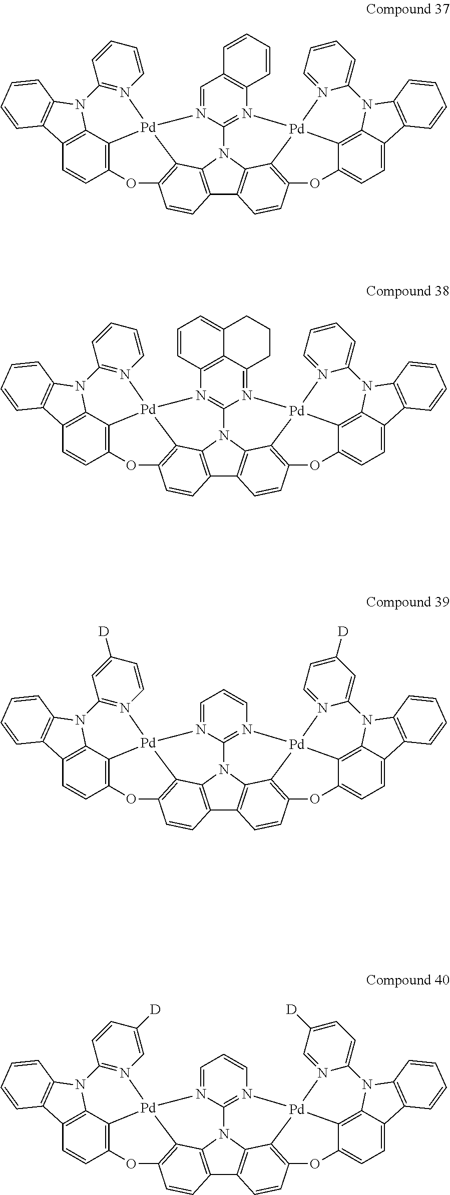

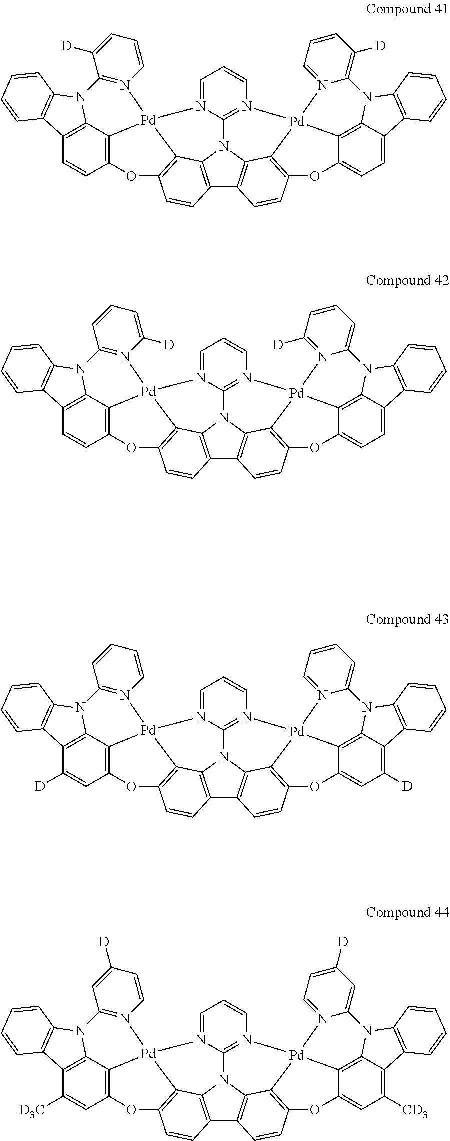

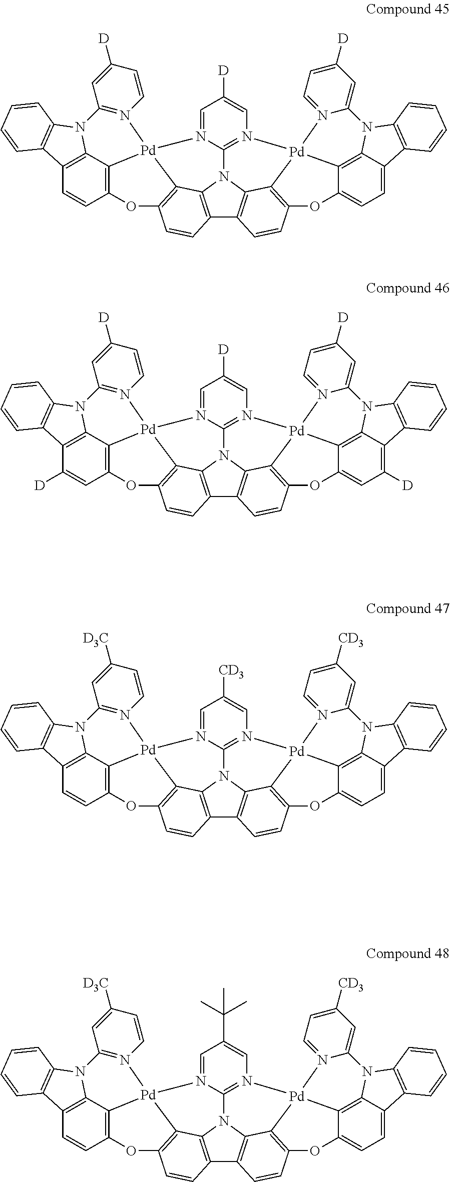

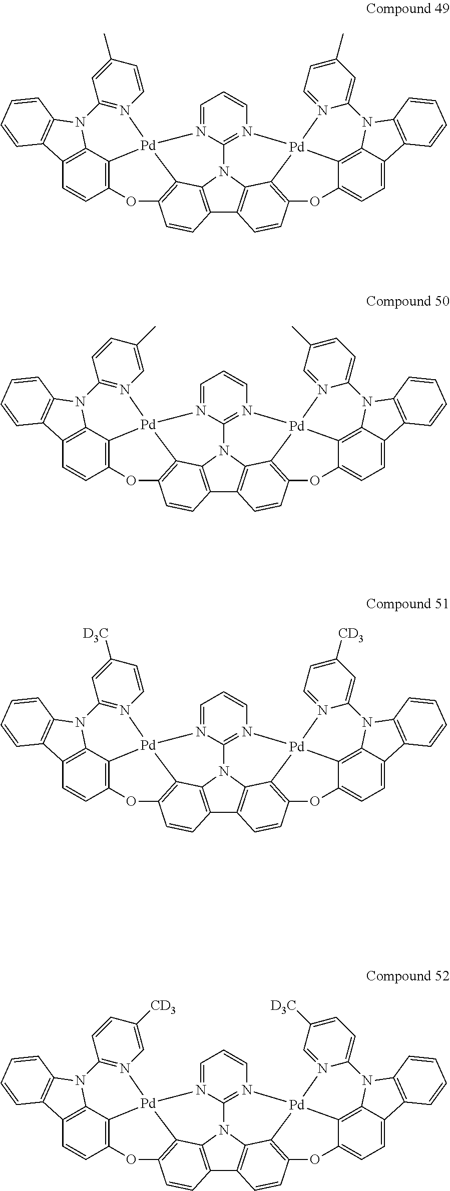

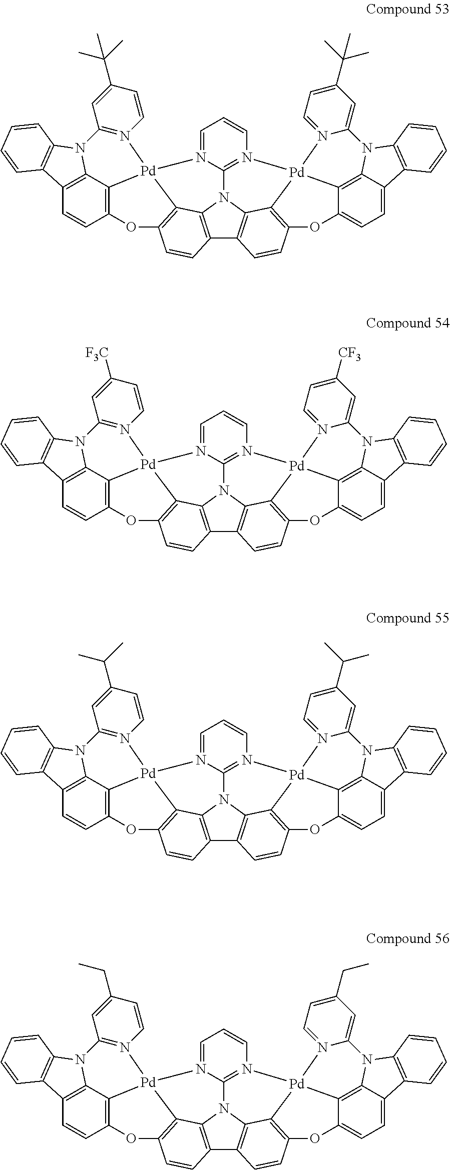

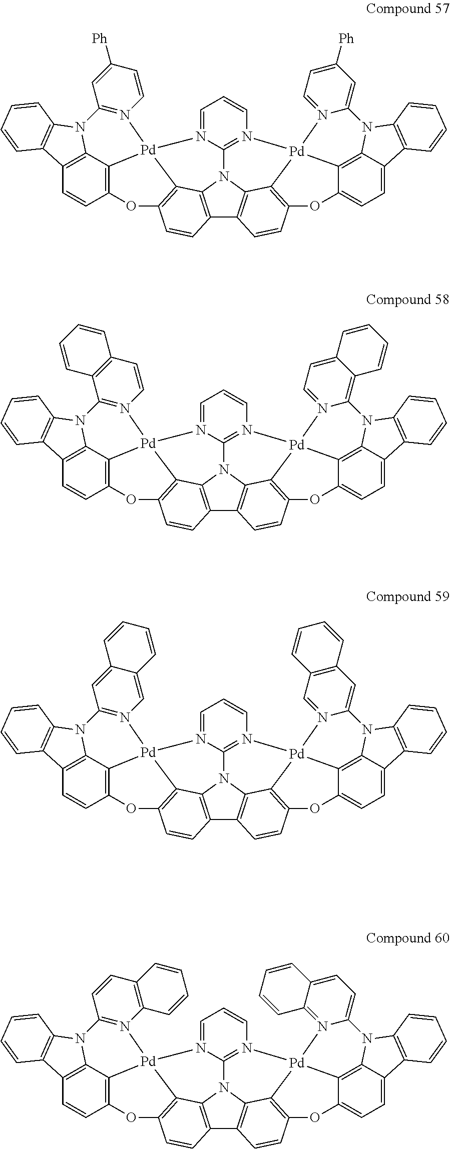

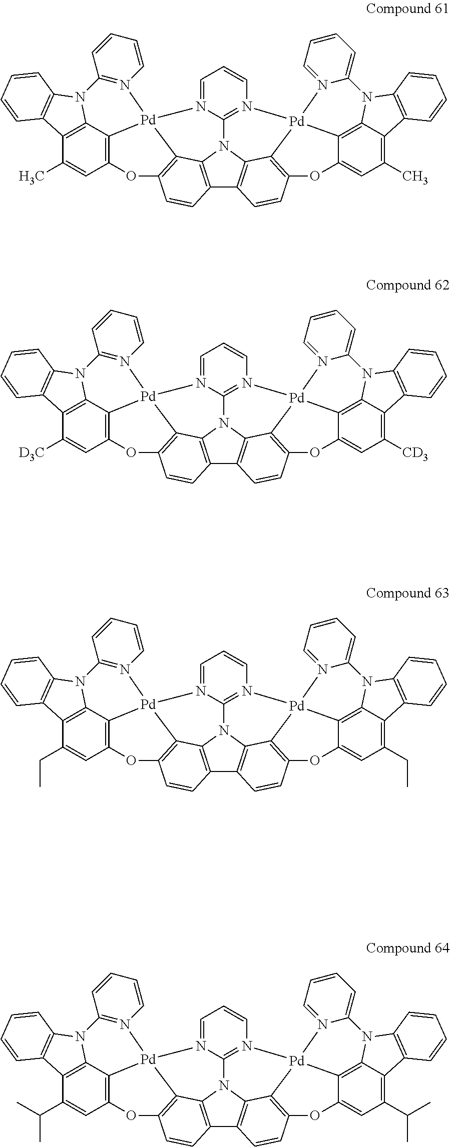

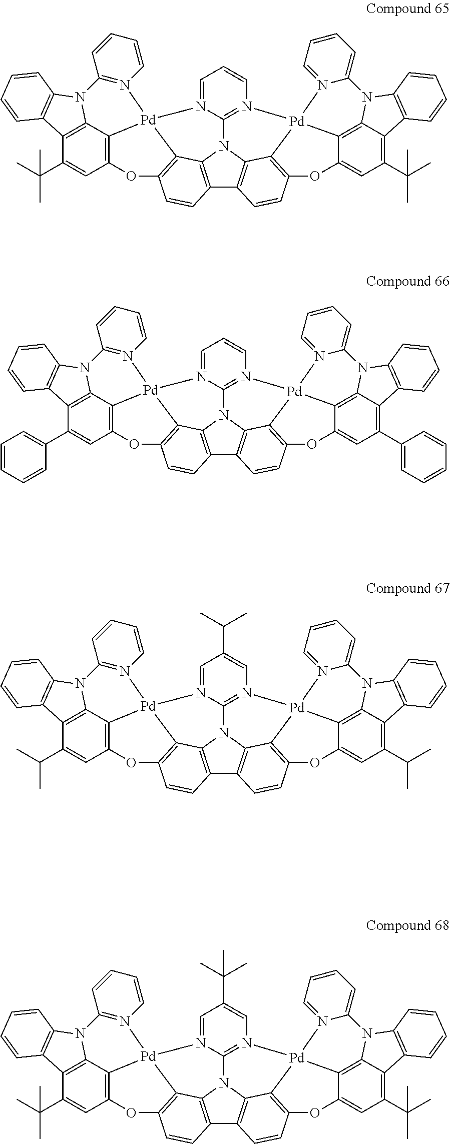

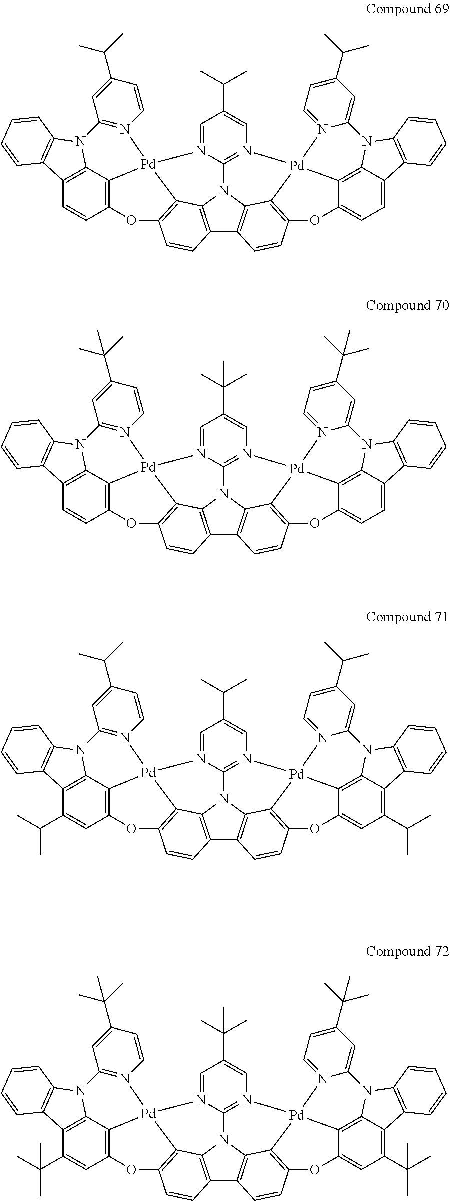

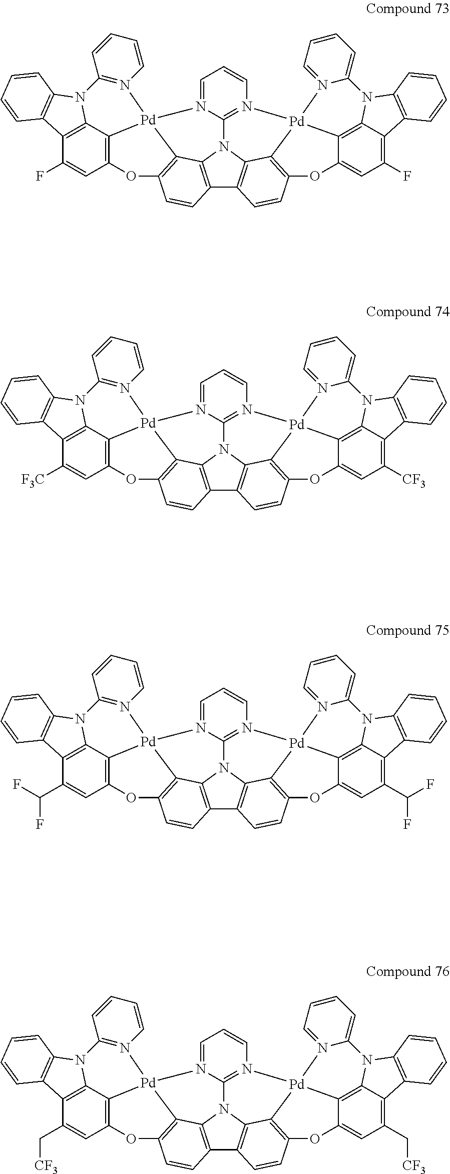

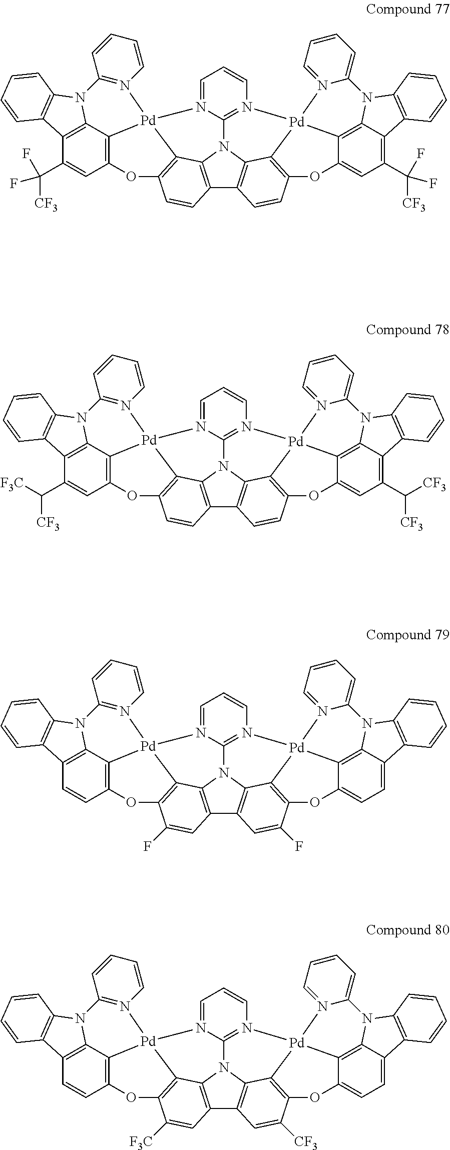

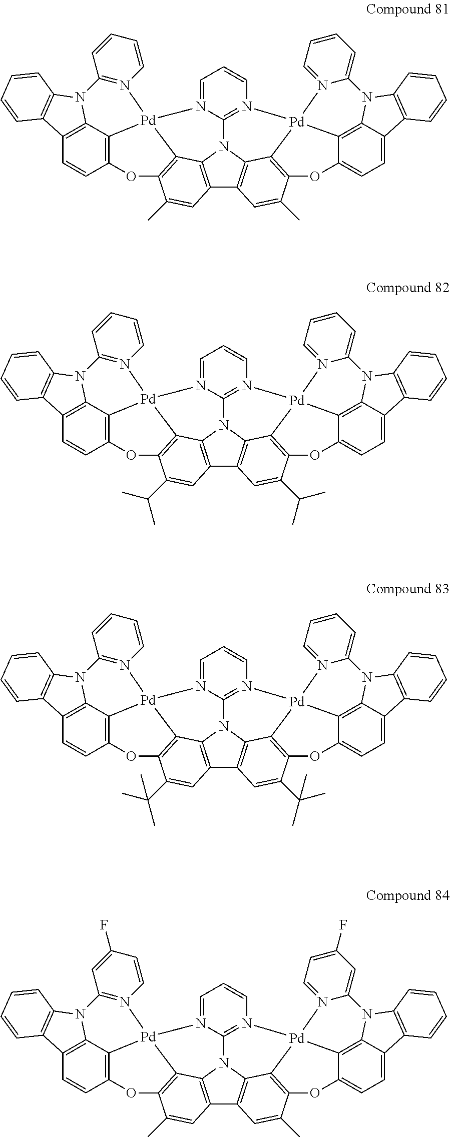

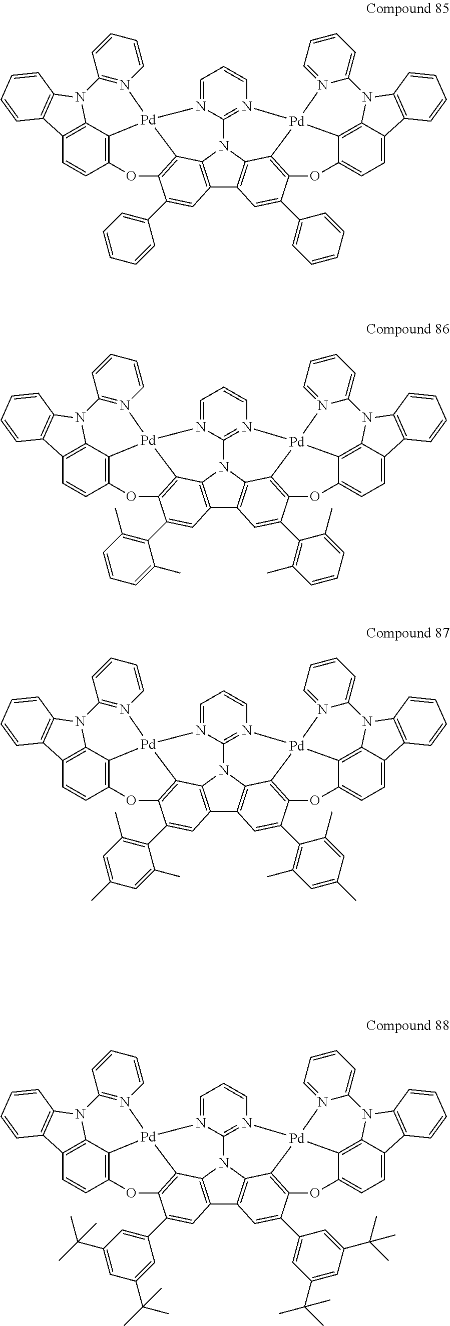

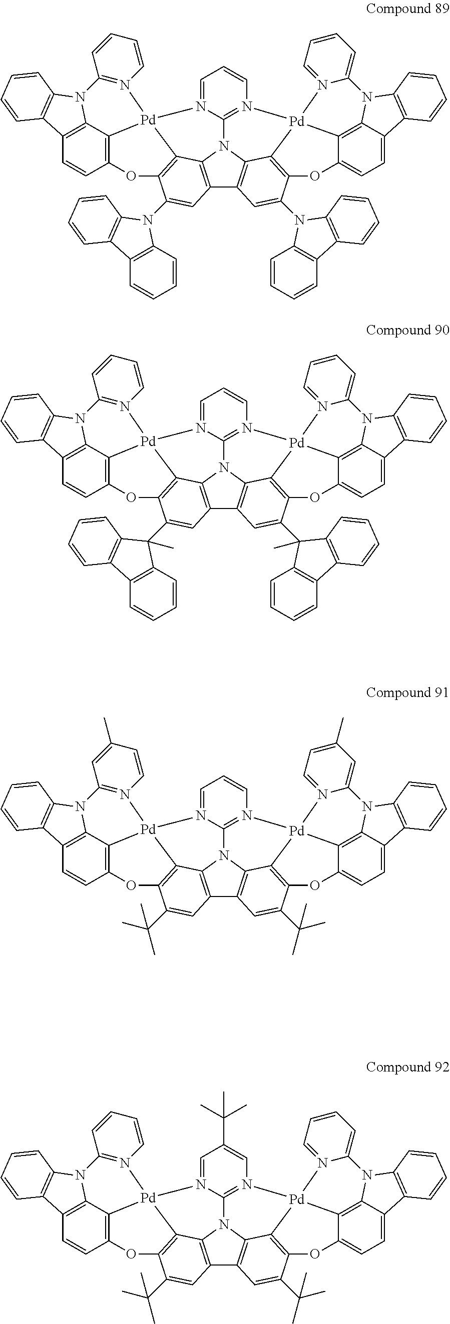

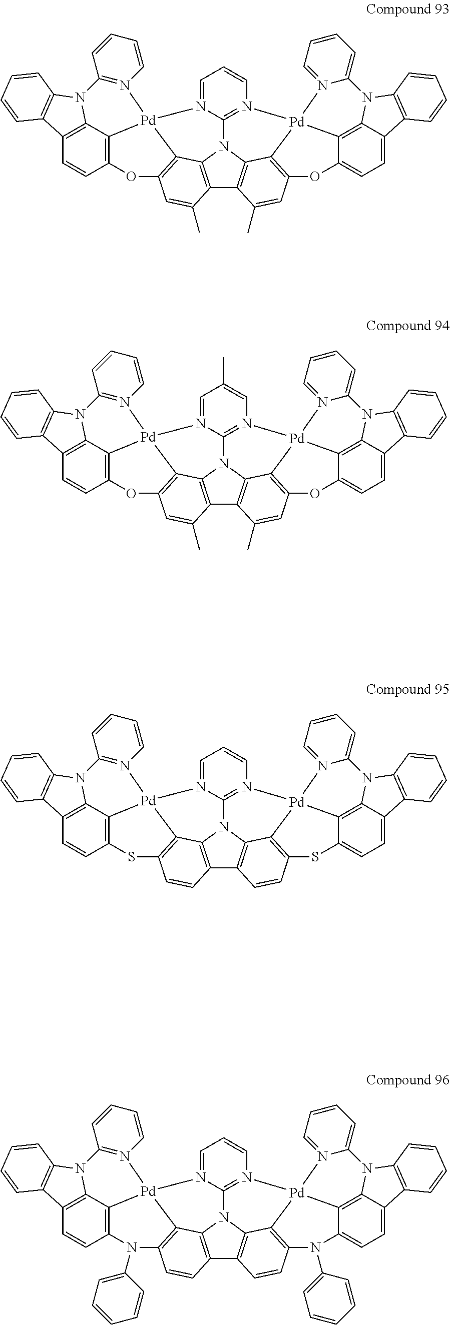

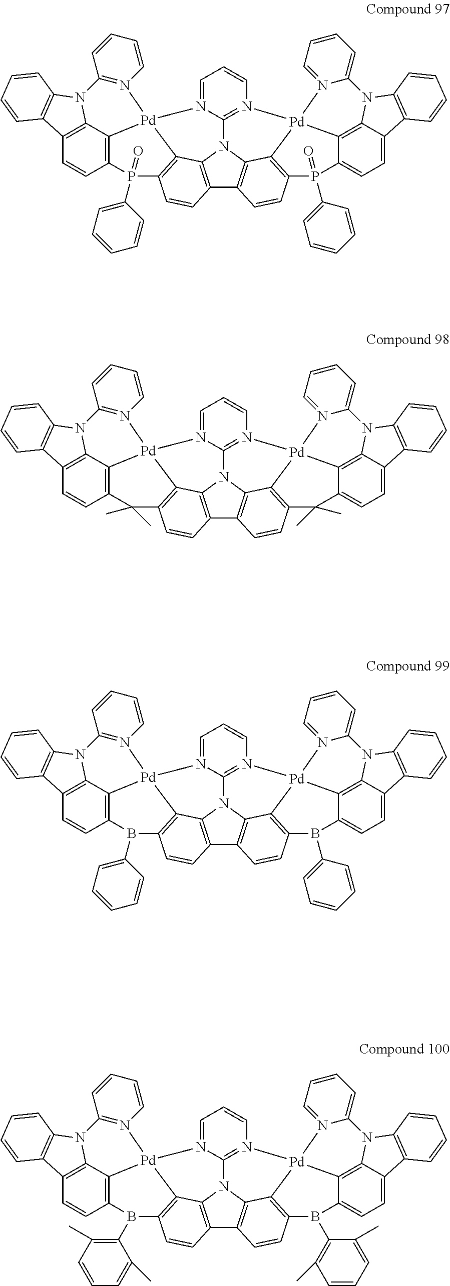

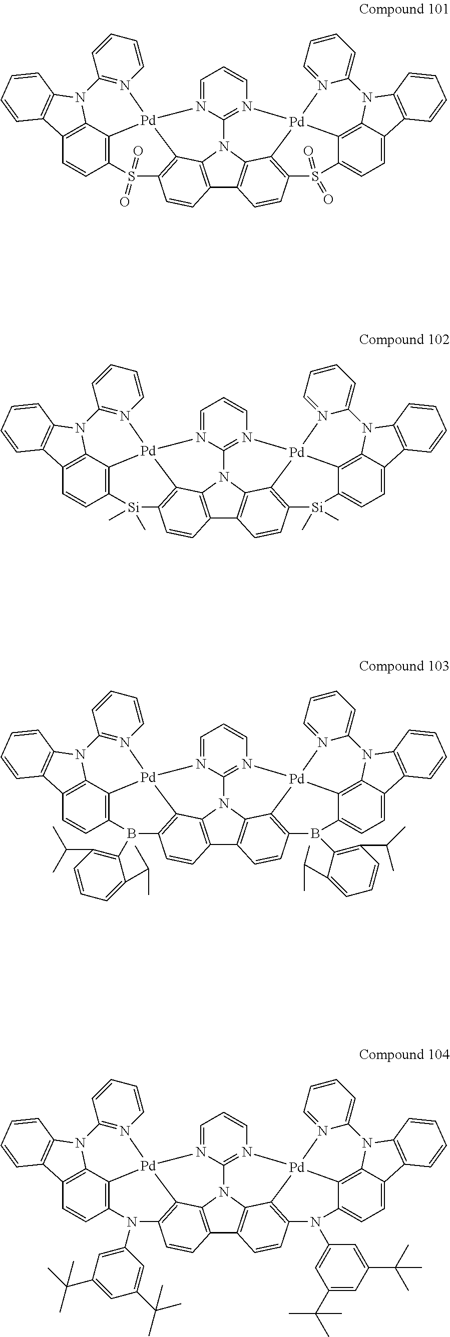

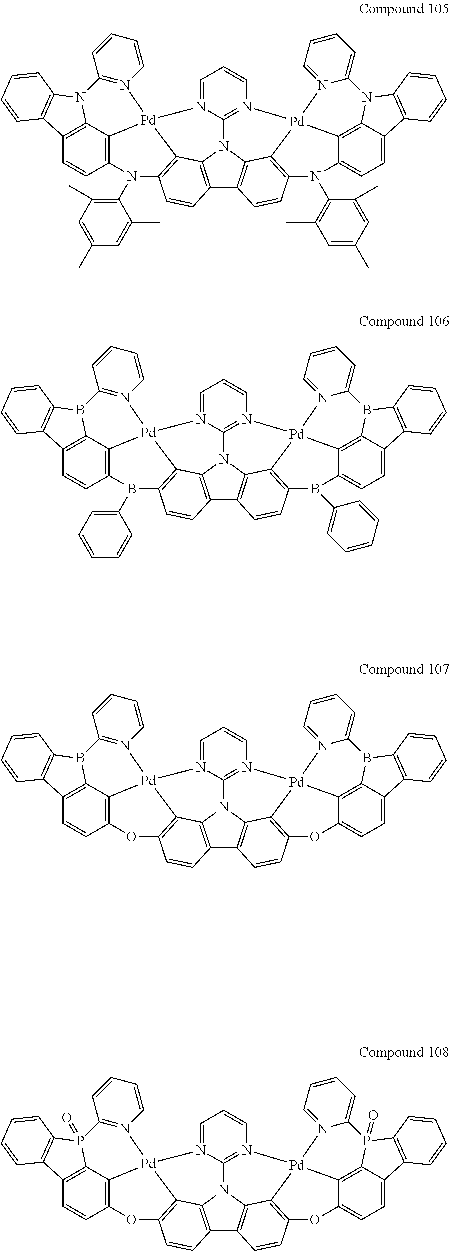

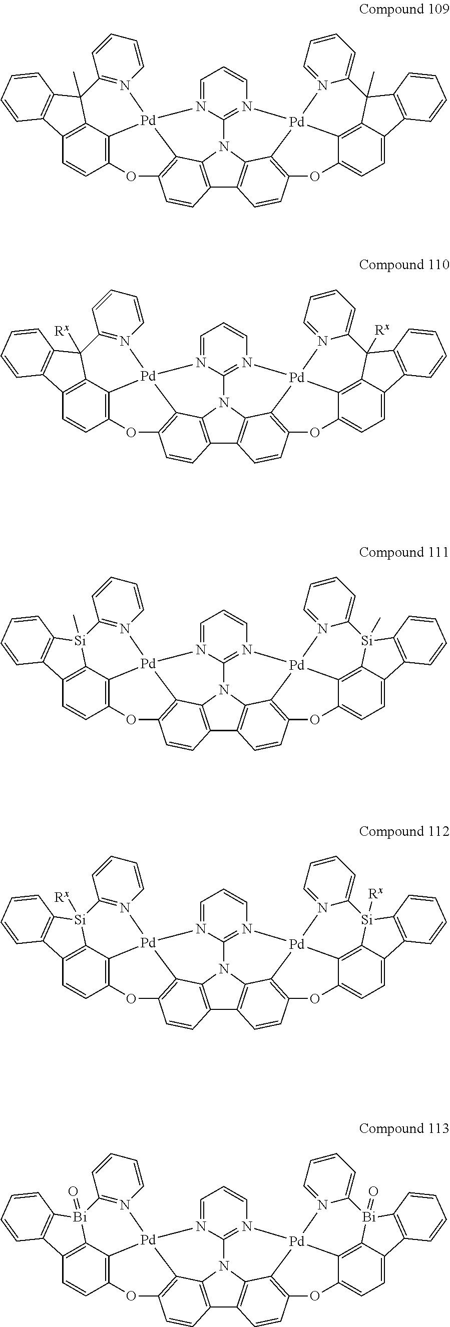

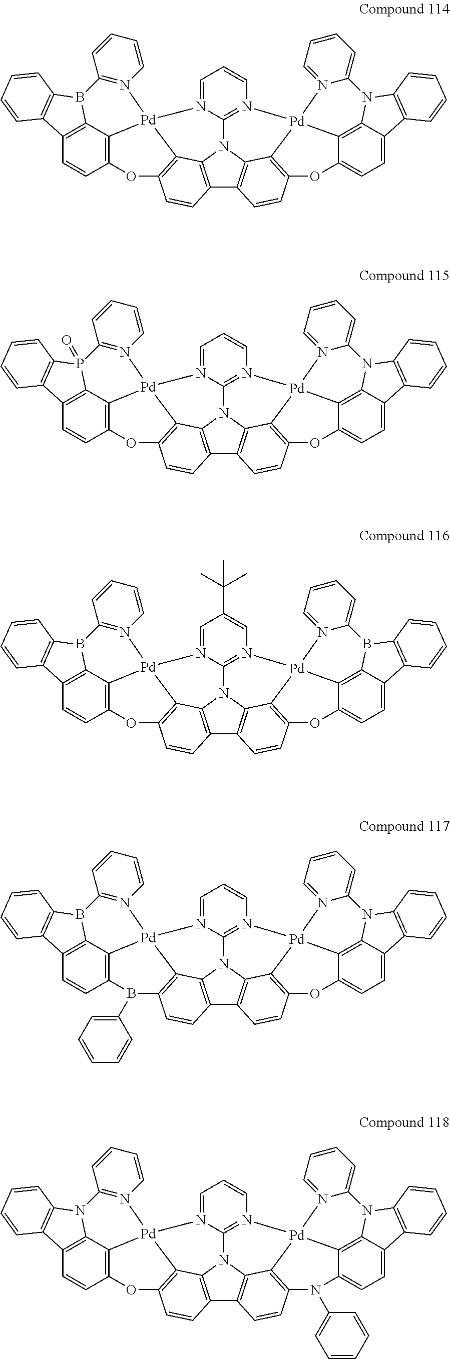

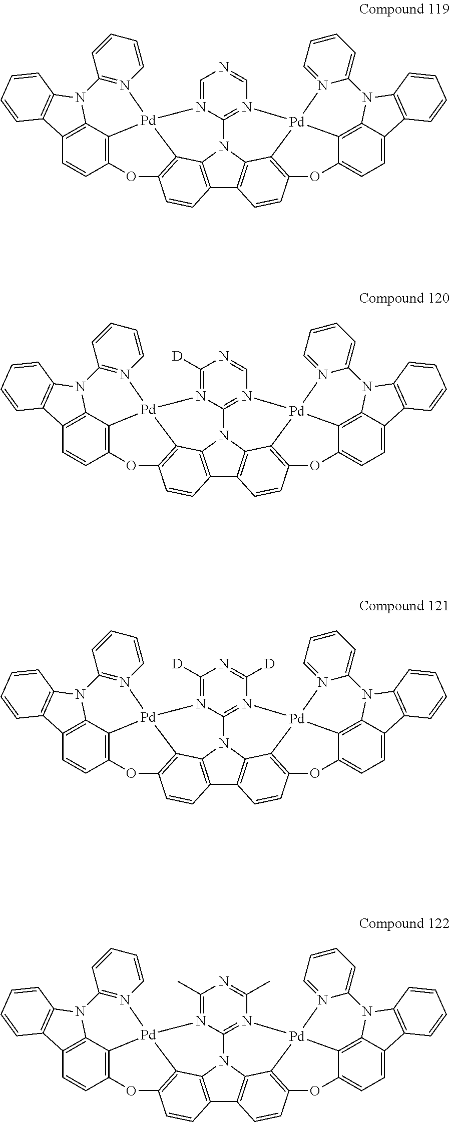

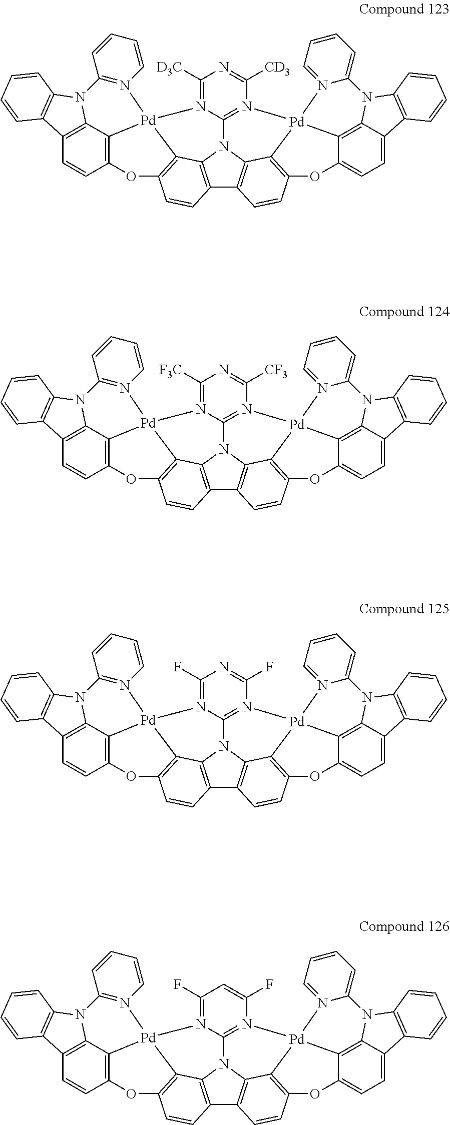

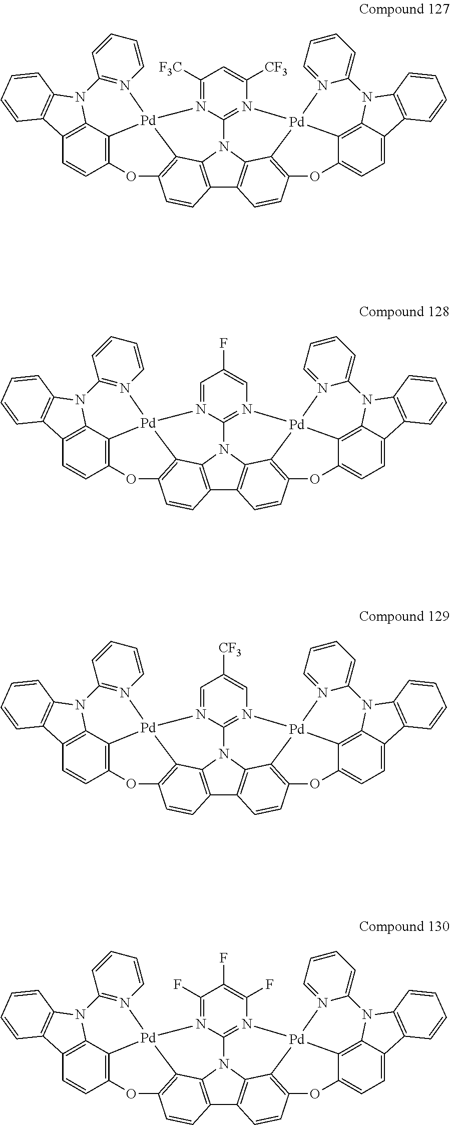

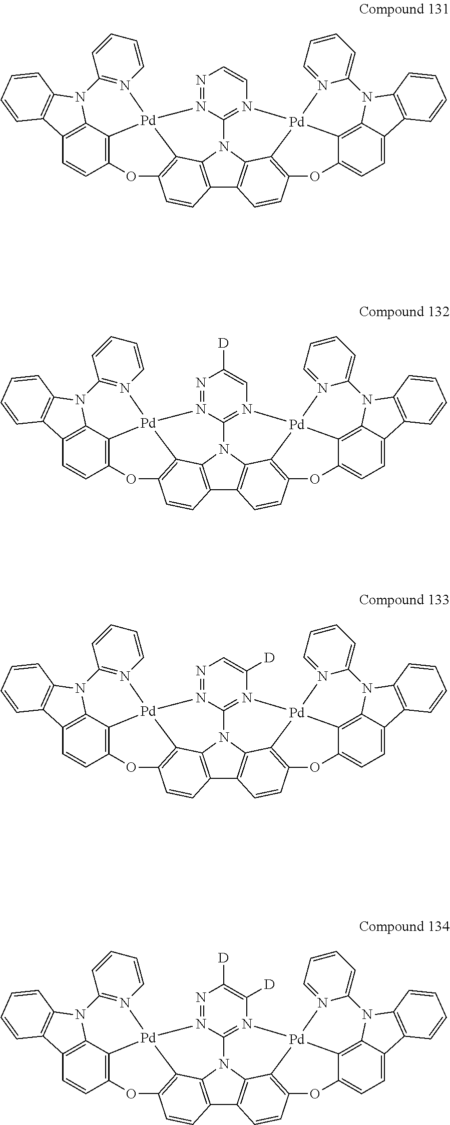

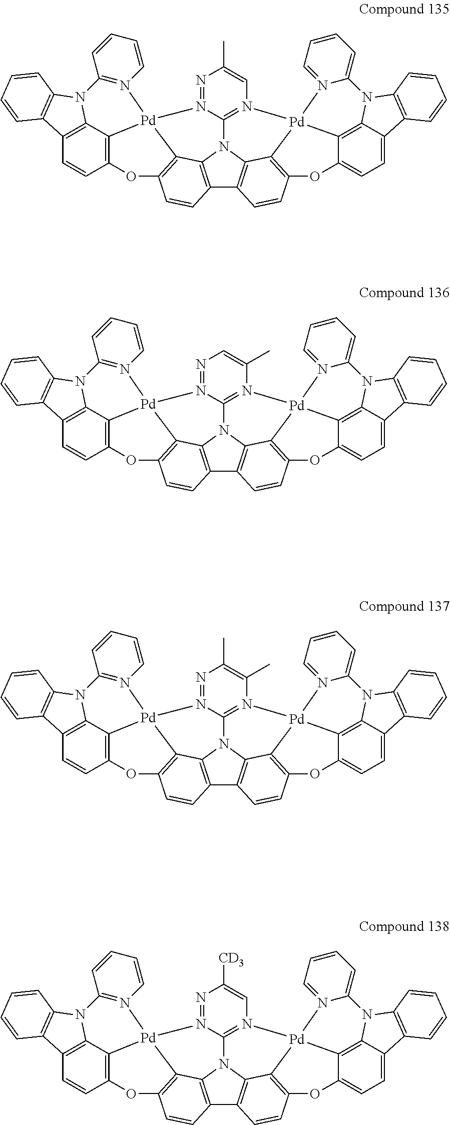

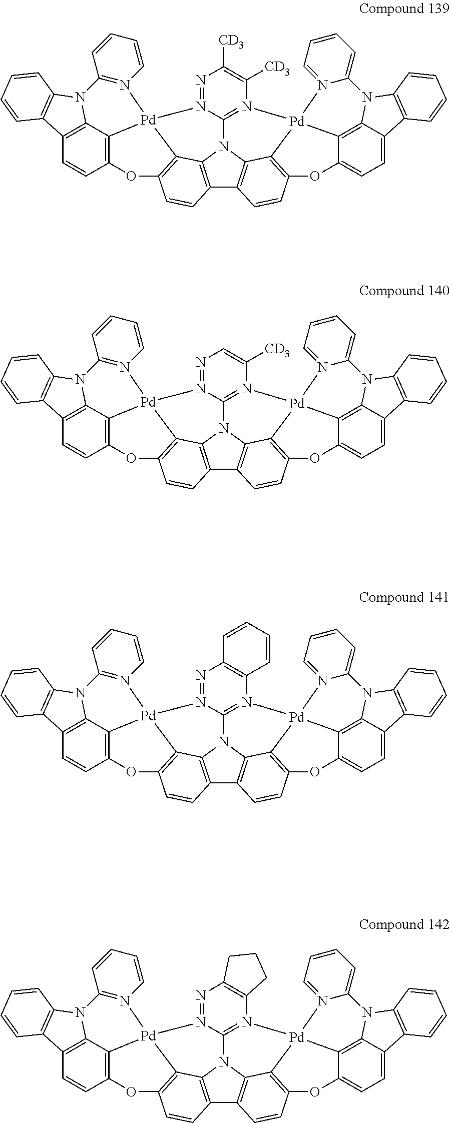

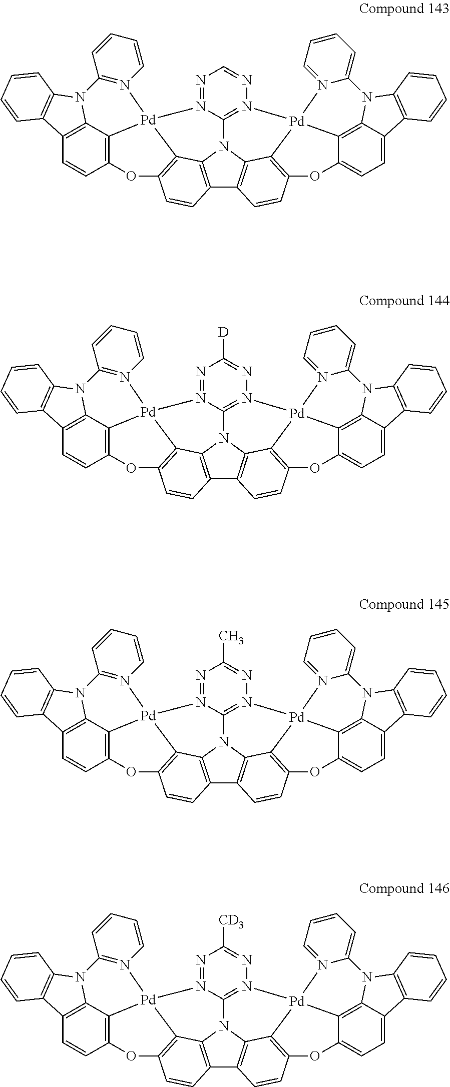

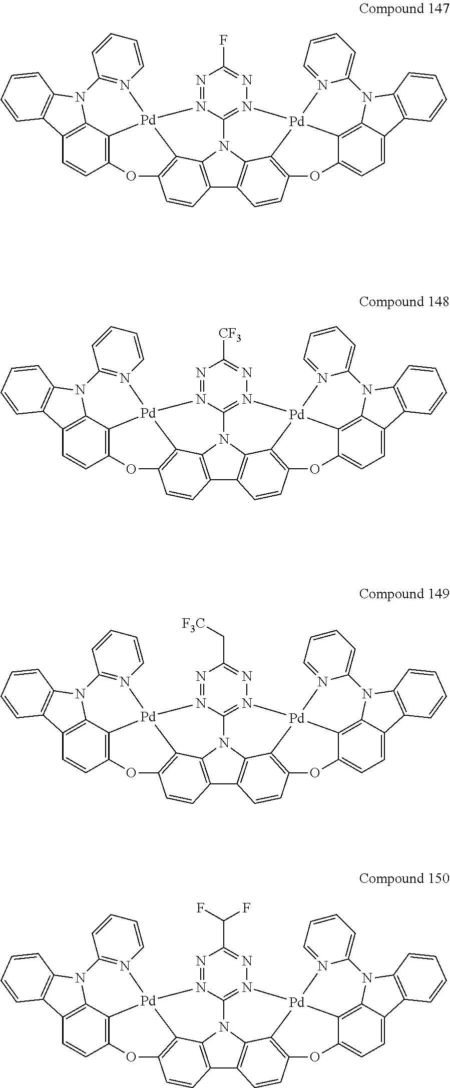

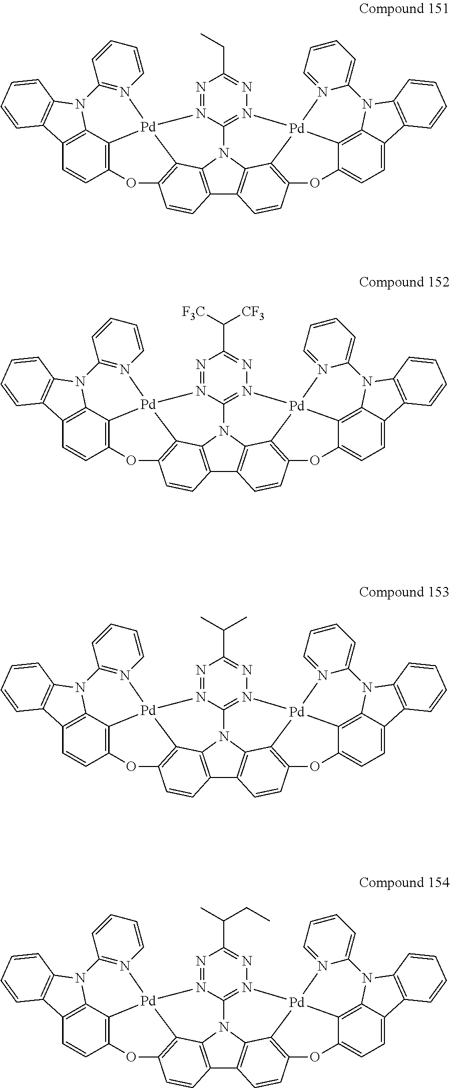

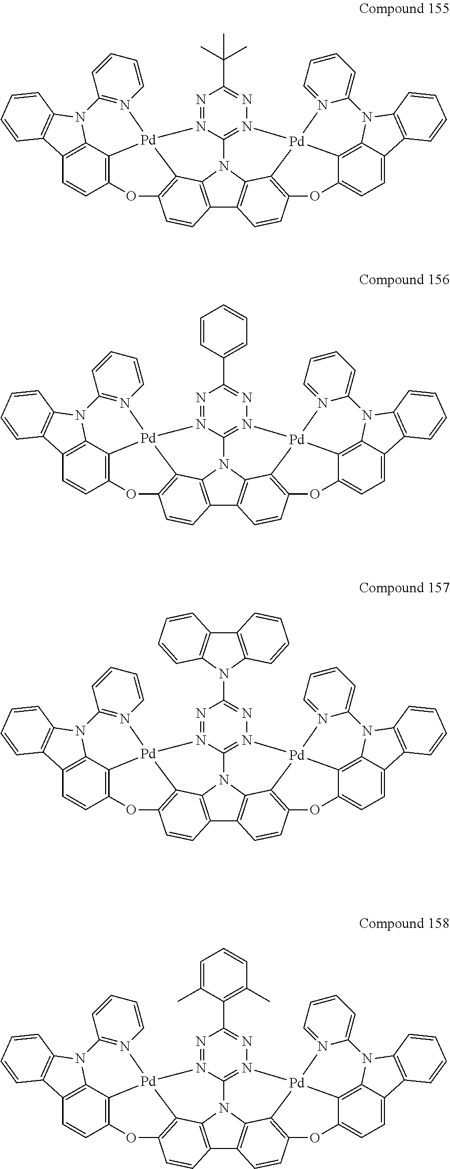

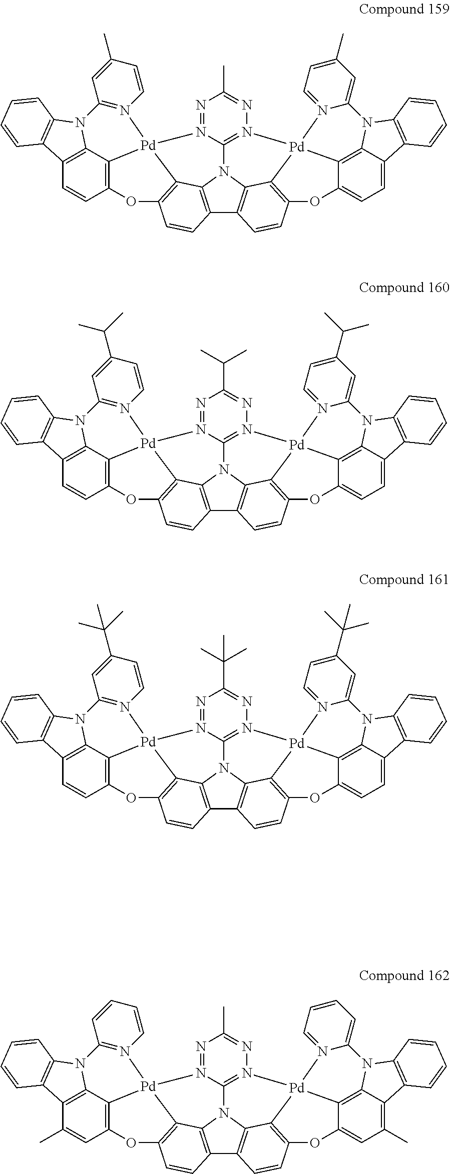

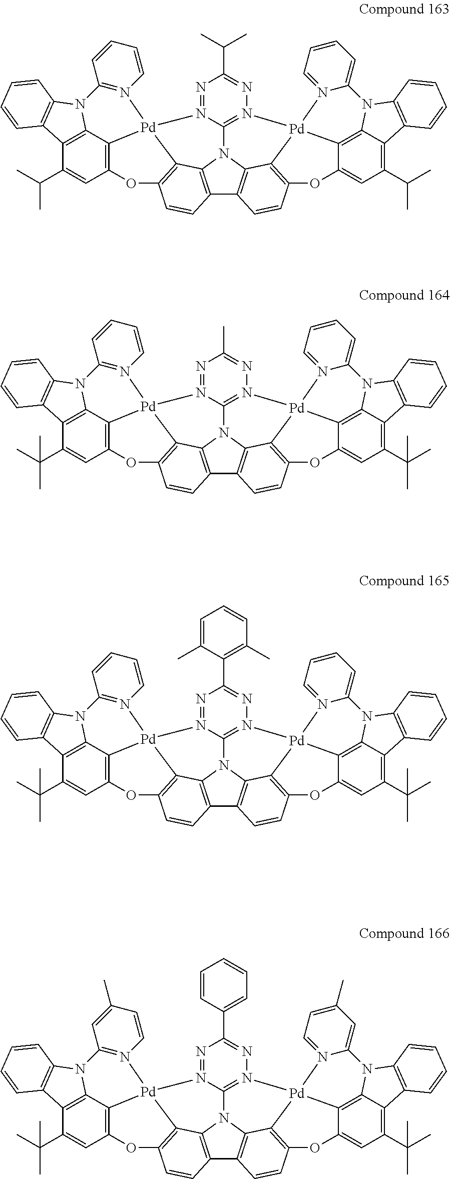

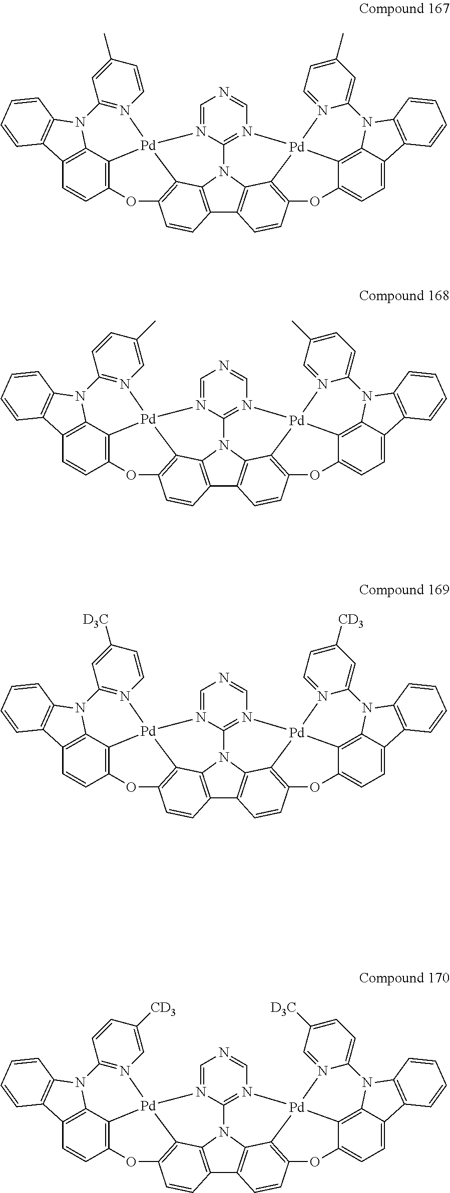

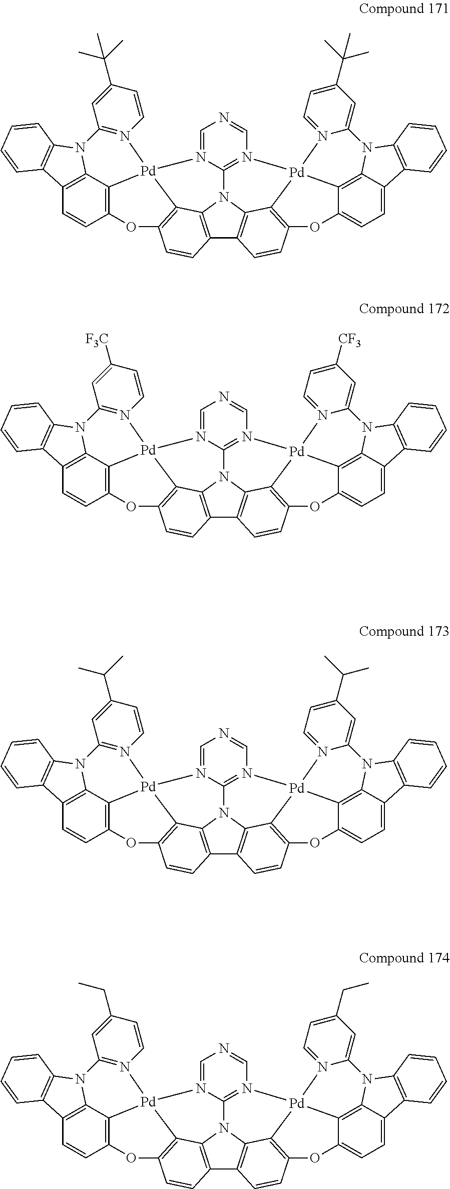

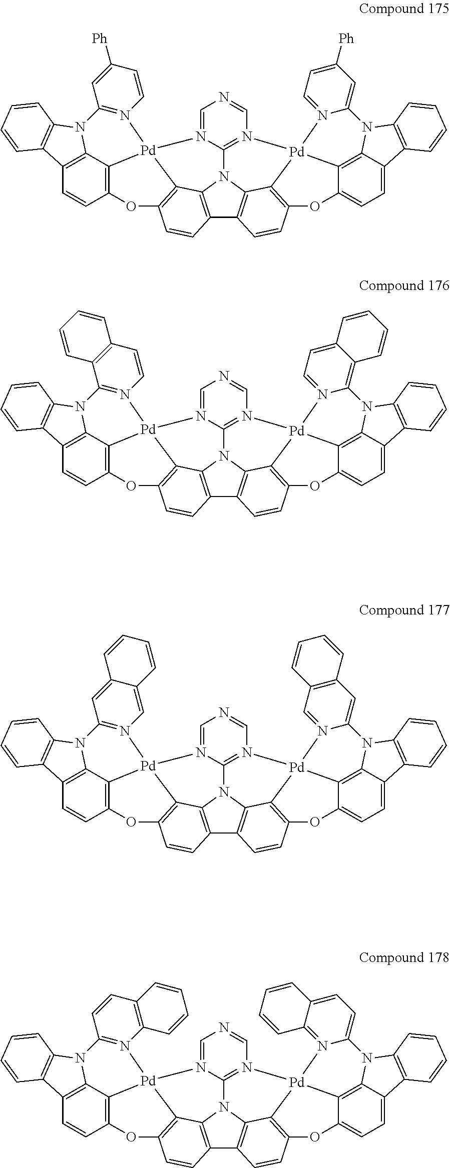

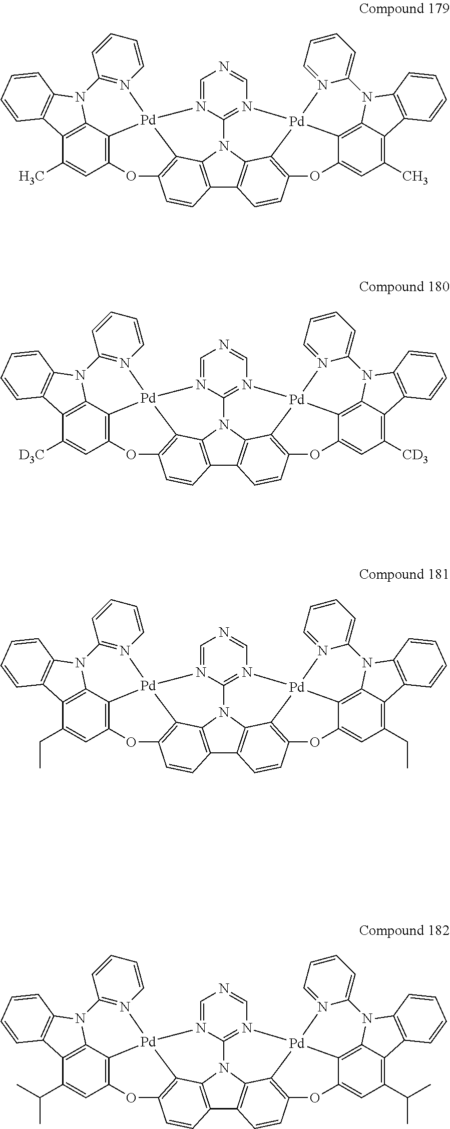

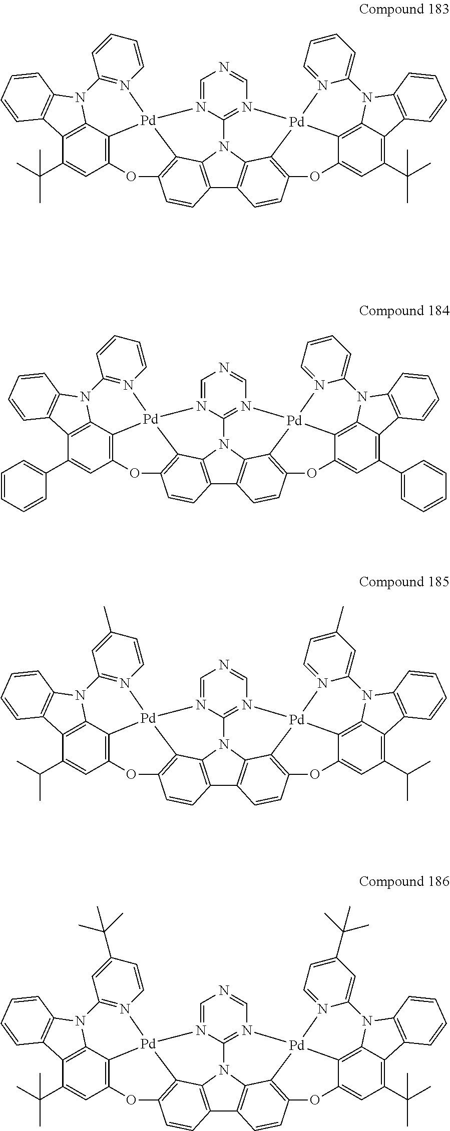

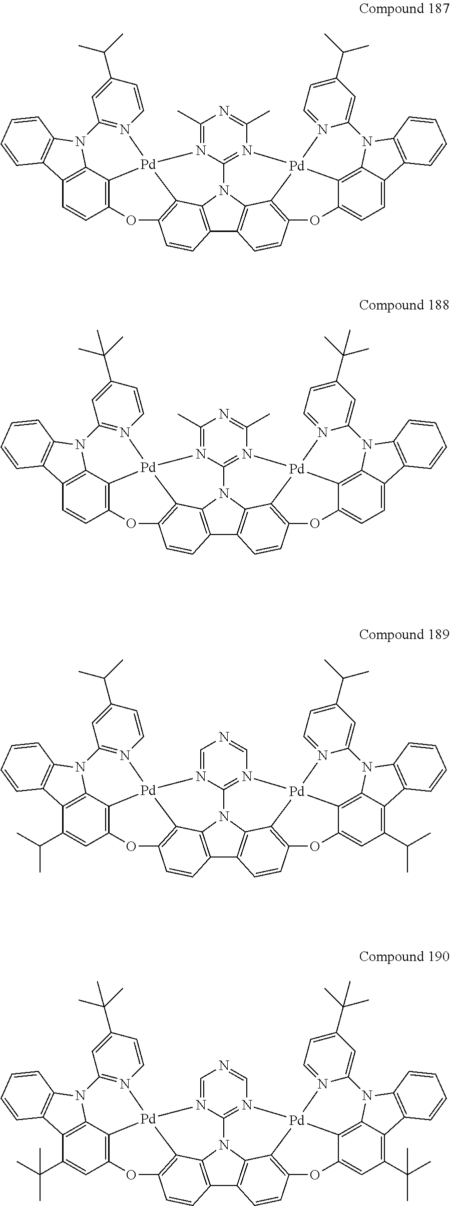

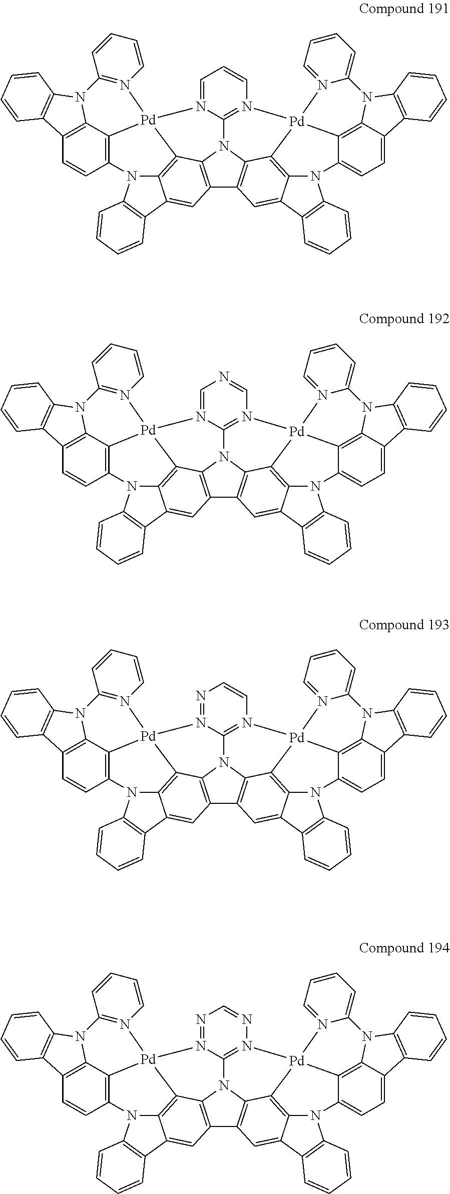

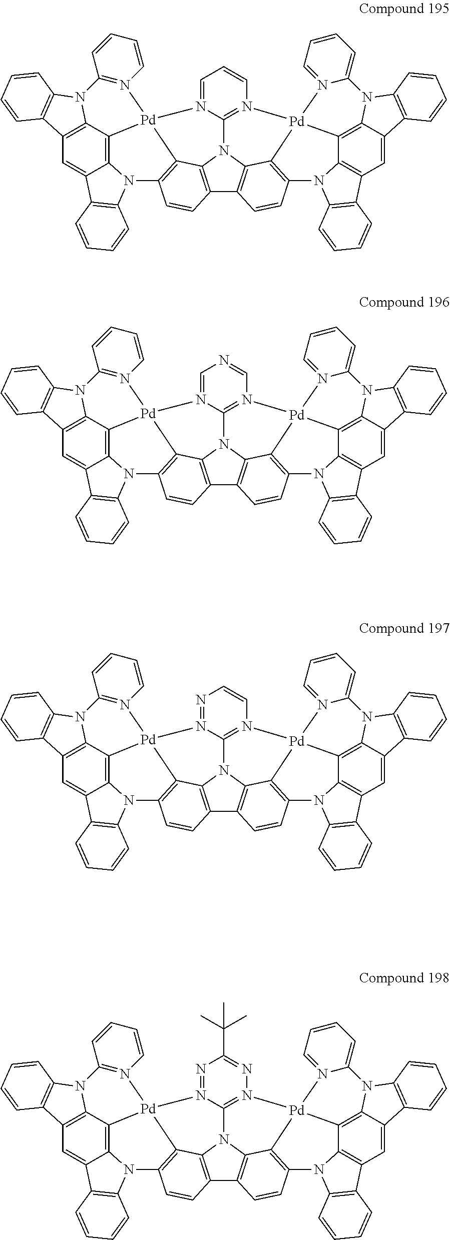

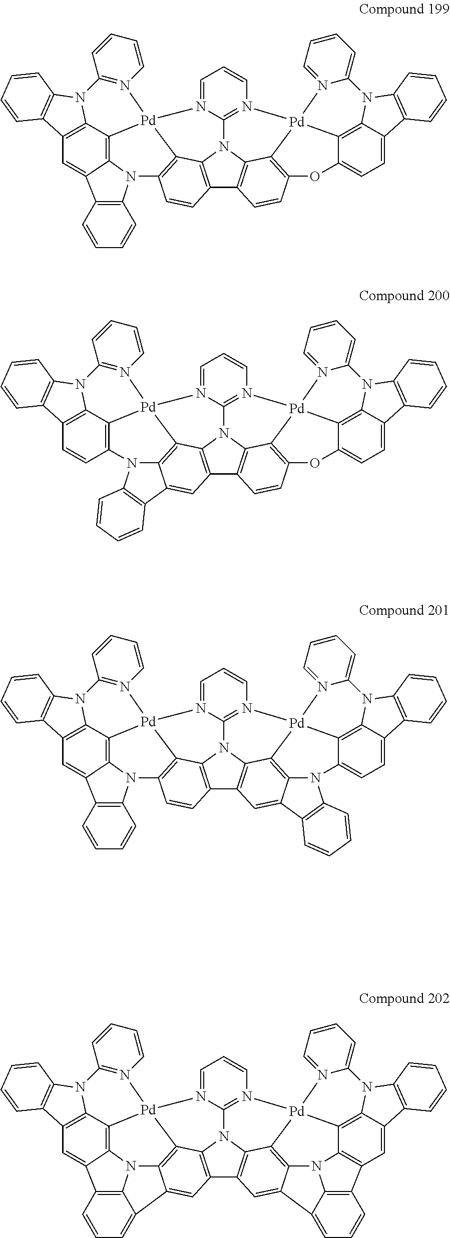

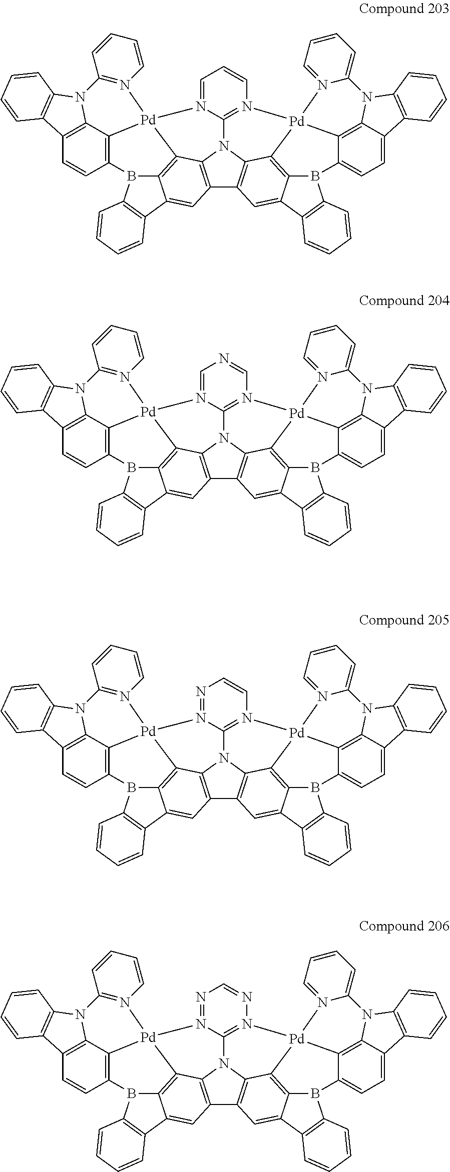

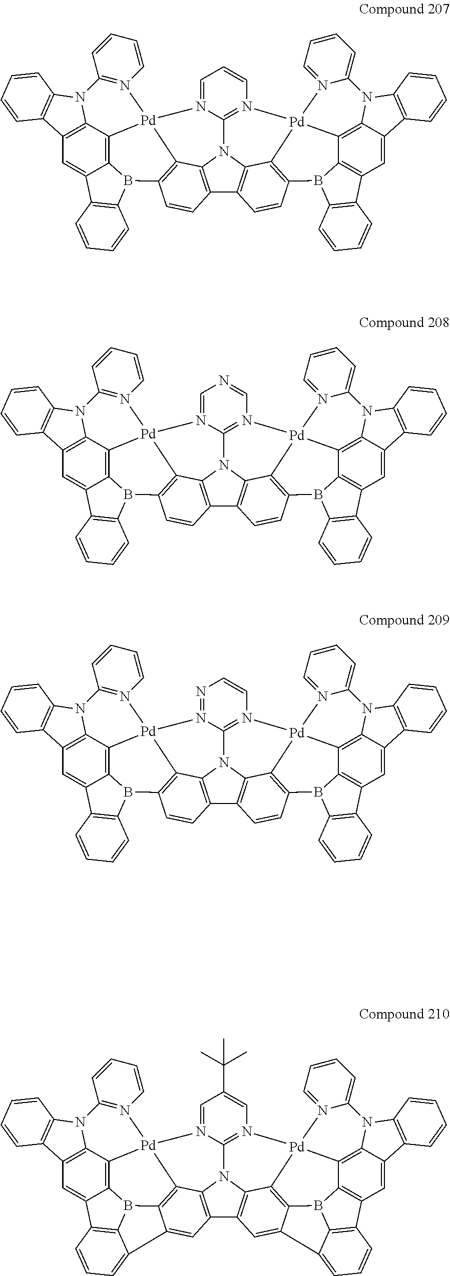

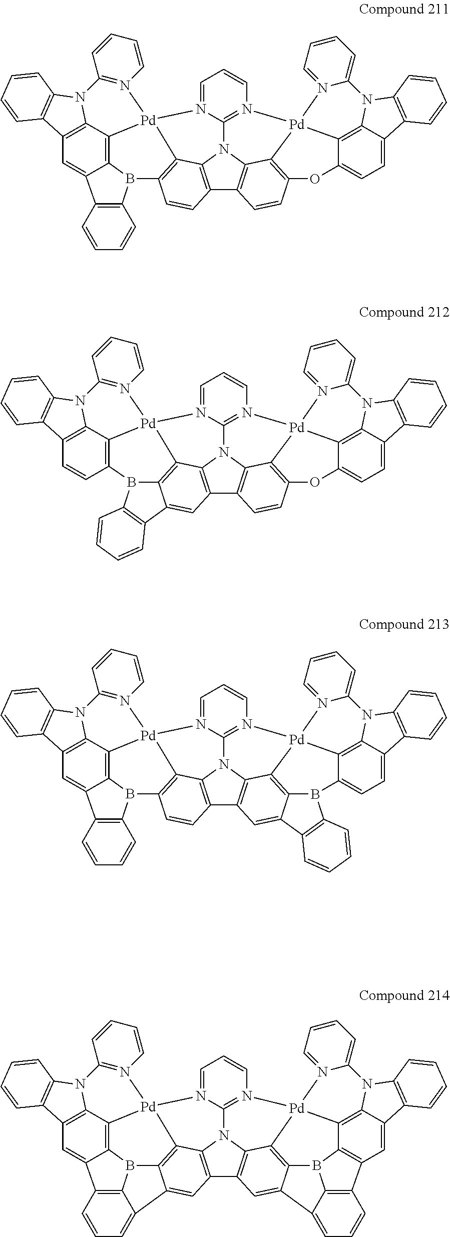

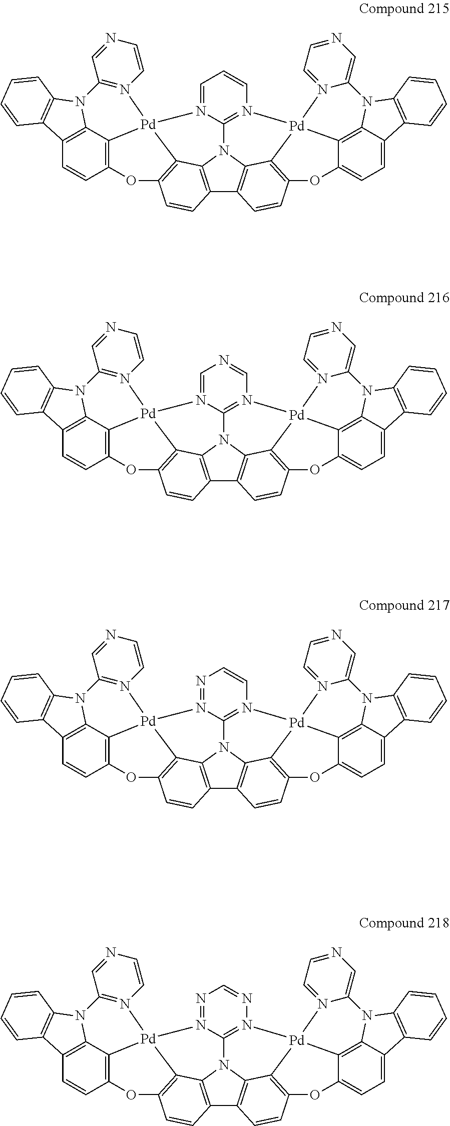

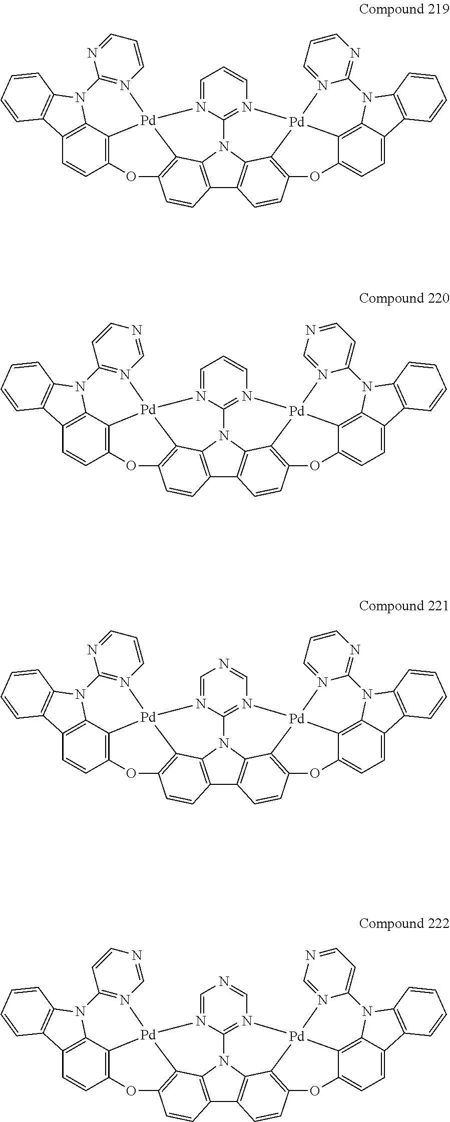

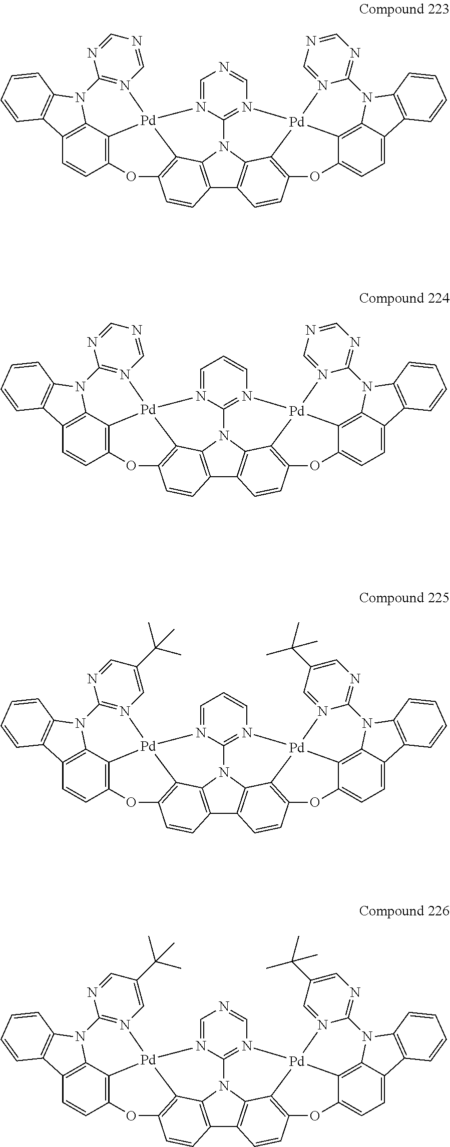

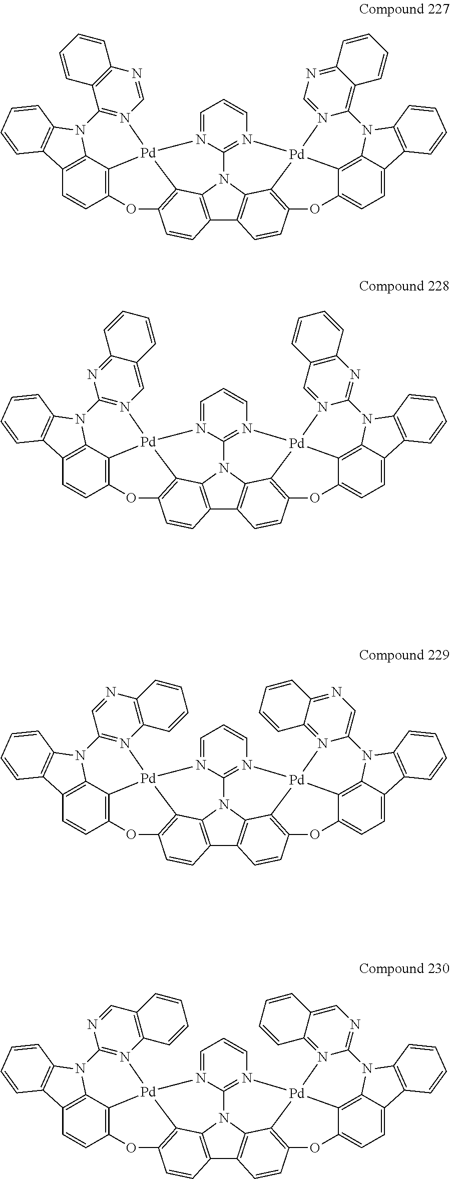

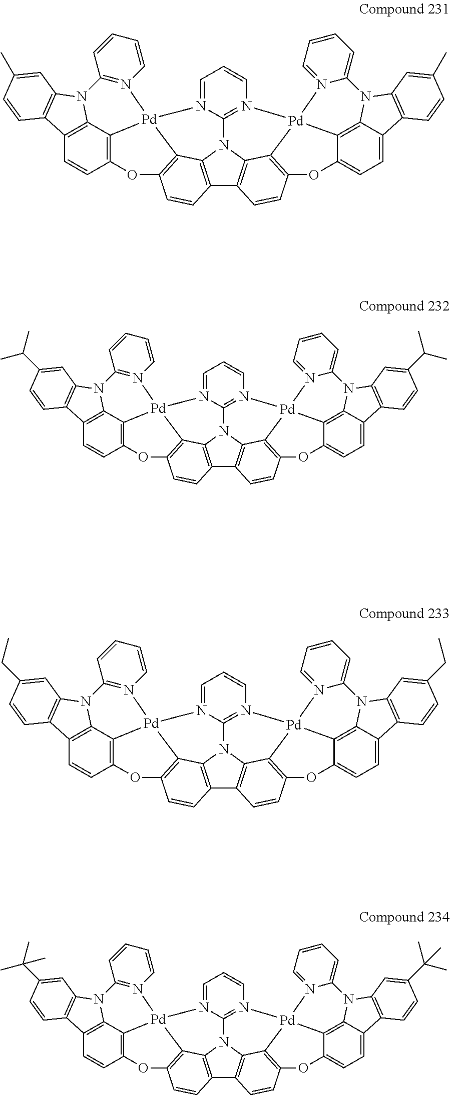

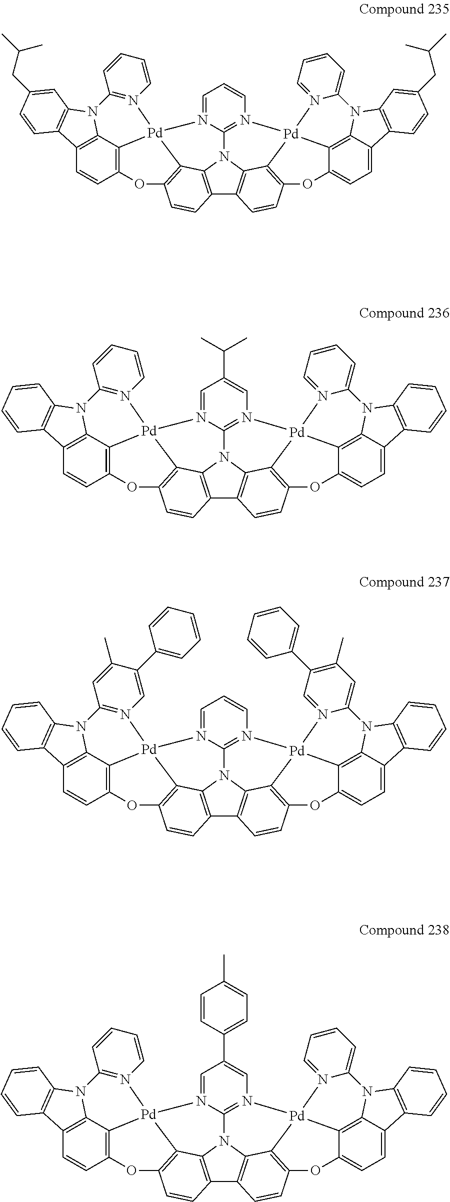

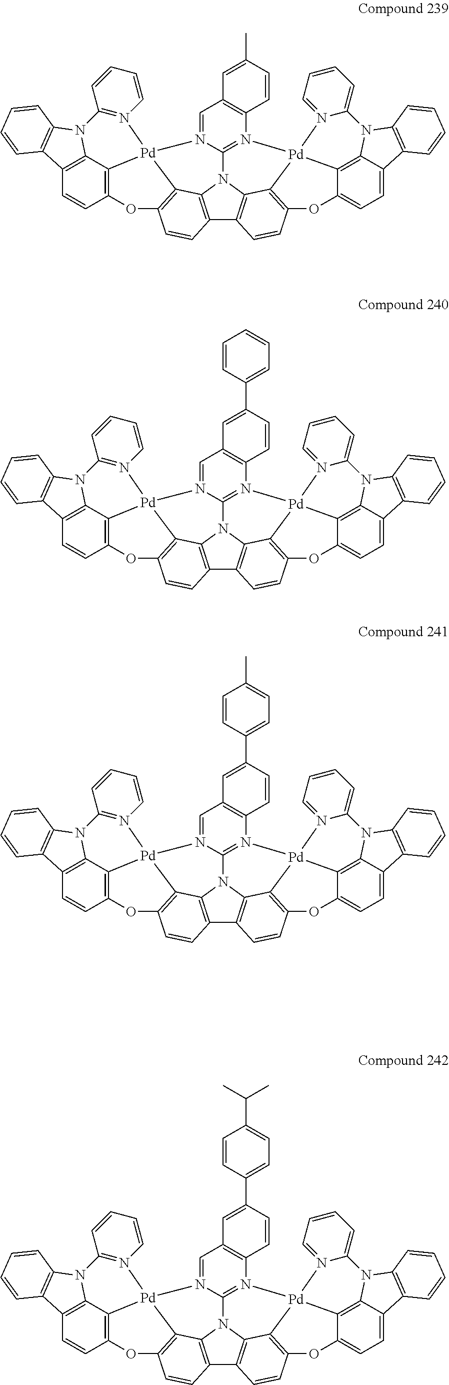

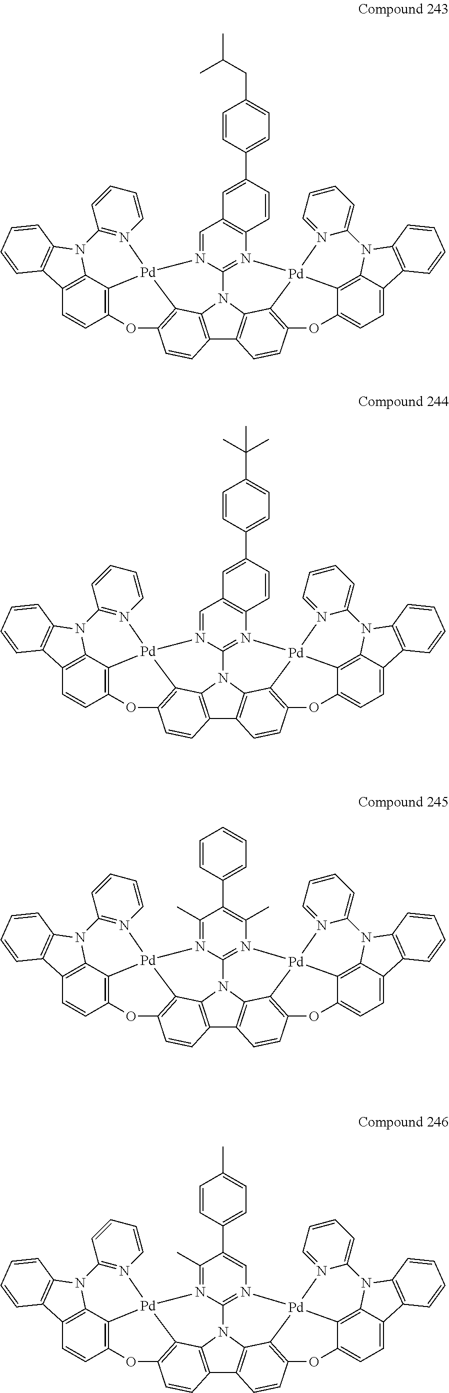

In which, R^{x} is selected from hydrogen, deuterium, halogen, hydroxyl, mercapto, nitro, cyanide, amino, carboxyl, sulfonyl, hydrazine, ureyl, substituted or unsubstituted C₁˜C₂₄ alkyl, substituted or unsubstituted C₂˜C₂₄ alkenyl, substituted or unsubstituted C₂˜C₂₄ akynyl, substituted or unsubstituted C₆˜C₃₆ aryl group, substituted or unsubstituted C₃˜C₁₈ heterocyclic group, substituted or unsubstituted C₃˜C₃₆ hetero-aryl, substituted or unsubstituted C₁˜C₂₄ alkoxy, substituted or unsubstituted C₁˜C₂₄ alkyl thioyl, substituted or unsubstituted C₂˜C₂₄ oxy, substituted or unsubstituted C₂˜C₂₄ alkynyl, substituted or unsubstituted C₂˜C₃₆ aryl, substituted or unsubstituted C₂˜C₂₄ alkoxy carbonyl, substituted or unsubstituted C₂˜C₃₆ ester, substituted or unsubstituted C₂˜C₃₆ amide, substituted or unsubstituted C₁˜C₃₆ sulfonyl group, substituted or unsubstituted C₁˜C₃₆ sulfonyl group, substituted or unsubstituted C₁˜C₃₆ sulfonylamino, substituted or unsubstituted C₁˜C₃₆ phosphoryl amine, substituted or unsubstituted C₂˜C₂₄ alkoxy carbonyl amine, substituted or unsubstituted C₇˜C₃₇ aryoxy carbonyl amino groups, substituted or unsubstituted methylsilyl alkyl, substituted or unsubstituted C₁˜C₁₈ monoalkylamines, substituted or unsubstituted C₂˜C₃₆ dialkylamino, substituted or unsubstituted C₆˜C₃₆ monoaryl amine, substituted or unsubstituted C₁₂˜C₇₂ his aryl amine, substituted or unsubstituted C₁˜C₃₆ ureylene, substituted or unsubstituted C₂˜C₃₆ imino; the substituents are selected from deuterium, halogen, hydroxyl, mercapto, nitro, cyanide, amino, carboxyl, sulfonyl, hydrazine, ureyl, C₁˜C₆ alkyl, C₆˜C₁₂ aryl group.

A method for preparing binuclear an organometallic complex of the embodiment of the present invention is further provided, and the intention of the specific synthesis example is only to disclose the contents of the invention instead of limiting the scope. Although great efforts have been made to ensure the accuracy of values (e.g. quantities, temperatures, etc.), some errors and deviations should be taken into account. Unless otherwise stated, the number of shares is weight, the temperature is in degrees Celsius or at ambient temperature, and the pressure is at or near atmospheric pressure.

There are various methods for preparing compounds disclosed by the present invention described in an embodiment. These methods are provided to illustrate various preparation methods instead being intended to limit any of the methods described in the embodiment of the present invention. Therefore, one or more disclosed compounds can be easily modified by the technical personnel in the domain of the invention or by using different methods. The following aspects are illustrative only instead of being intended to limit the scope of this disclosure. The temperature, catalyst, concentration, reactant composition, and other process conditions may be varied, and the technical staff in the field of the content of the disclosure can easily select suitable reactants and conditions for desired complexes.

¹H spectra are recorded by 400 MHz in CDCl₃ or DMSO-d6 solution on Varian Liquid State NMR instrument, and ¹³C NMR spectra are recorded at 100 MHz, and the chemical shifts are compared with the residual protiated solvents. If CDCl₃ is used as solvent, tetramethylsilane (δ=0.00 ppm) is used as internal standard to record ¹H NMR spectra; DMSO-d₆ (δ=77.00 ppm) is used as the internal standard recording ¹³C NMR spectra. If H₂O (δ=3.33 ppm) is used as the solvent, the residual H₂O (δ=3.33 ppm) is used as internal standard to record ¹H NMR spectra; DMSO-d₆ (δ=39.52 ppm) is used as the internal standard to record ¹³C NMR spectra. The following abbreviations (or combinations) are used to explain the multiplicity of ¹H NMR: s=single, d=double, t=triple, q=quadruple, p=quintuple, m=multiple, br=width.

The preparation method of binuclear organometallic complexes in the embodiment of the invention comprises at least the following steps:

Step 1, preparation of precursor substances as shown in general formulas A and B;

Step 2, preparation of precursor substances as shown in general formula C and general formula D;

Step 3, the intermediate as shown in the general formula Ligand is obtained by substitution reaction of the precursor substance shown in general formula A and general formula D, or by substitution reaction of the precursor substance shown in the general formula B and formula. C.

Step 4: the intermediate shown by general formula Ligand is reacted with palladium salt to obtain the compound shown in general formula I where A¹, A² is oxygen and X¹, X², X³ is nitrogen;

The following generic synthesis routes is shown as follows, with n₁, n₂, n₃, n₄, n₅, n₆, and n₇ as 1. It should be understood that R¹, R², R³, R⁴, R⁵, R⁶, R⁷ can also be set up in multiple ways:

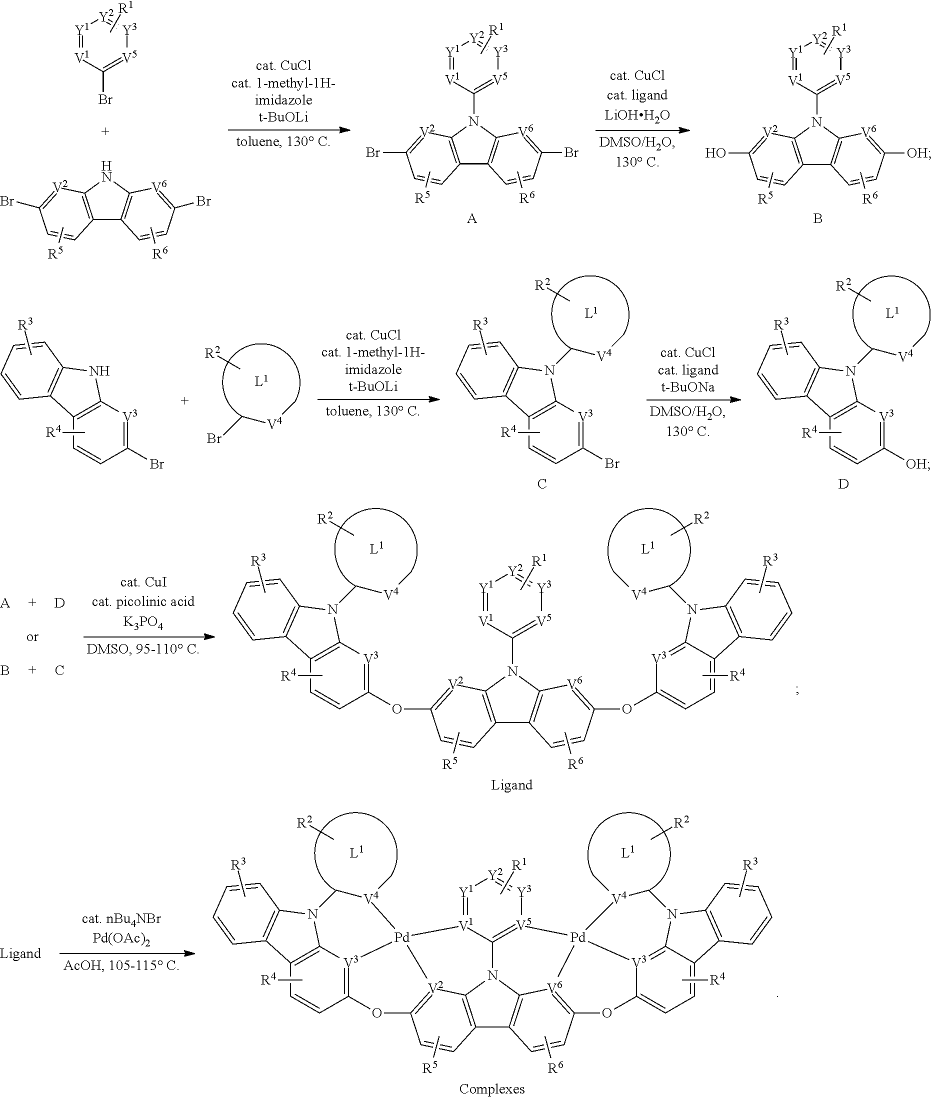

The preparation method of binuclear organometallic complexes in the embodiment of the invention comprises at least the following steps:

Step 1, preparation of precursor substances as shown in general formulas A and B;

Step 2, preparation of precursor substances as shown in general formula C and general formula. E;

Step 3, the intermediate as shown in the general formula Ligand is obtained by substitution reaction of the precursor substance shown in general formula A and general formula E,

Step 4: the intermediate shown by general formula Ligand is reacted with palladium salt to obtain the compound shown in general formula I Where A¹, A⁴ is nitrogen and X¹, X², X³ is nitrogen;

The following generic synthesis routes is shown as follows, with n₁, n₂, n₃, n₄, n₅, n₆, and n₇ as 1. It should be understood that R¹, R², R³, R⁴, R⁵, R⁶, R⁷ can also be set up in multiple ways:

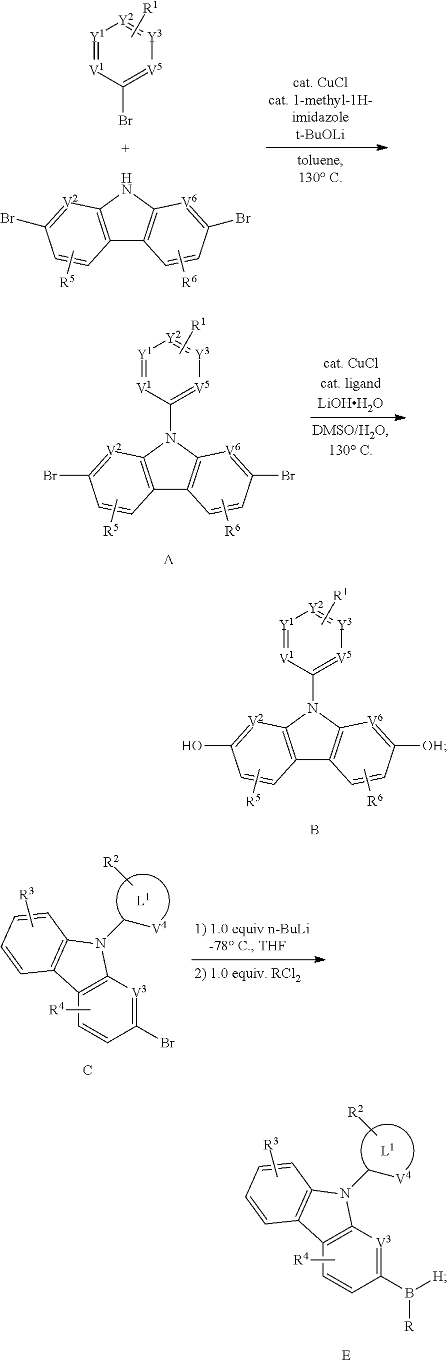

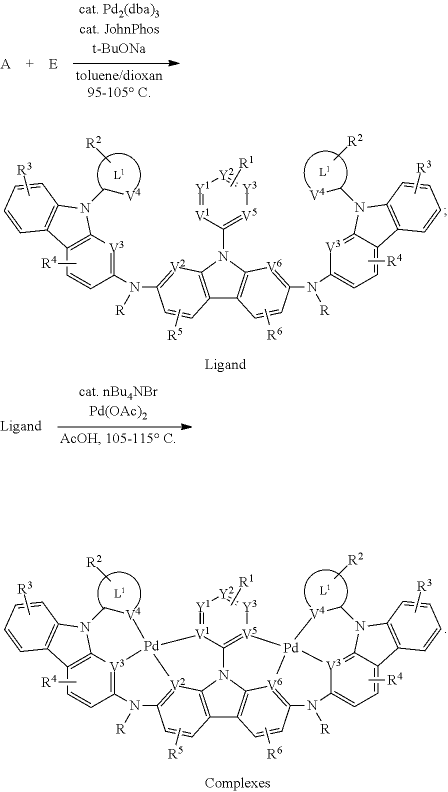

The preparation method of binuclear organometallic complexes in the embodiment of the invention comprises at least the following steps:

Step 1, preparation of precursor substances as shown in general formulas A and B;

Step 2, preparation of precursor substances as shown in general formula C and general formula F;

Step 3, the intermediate as shown in the general formula Ligand is obtained by substitution reaction of the precursor substance shown in general formula A and general formula F

Step 4: the intermediate shown by general formula Ligand is reacted with palladium salt to obtain the compound shown in general formula I Where A¹, A⁴ is boron and X¹, X², X³ is nitrogen

The following generic synthesis routes is shown as follows, with n₁, n₂, n₃, n₄, n₅, n₆, and n₇ as 1. It should be understood that R¹, R², R³, R⁴, R⁵, R⁶, R⁷ can also be set up in multiple ways:

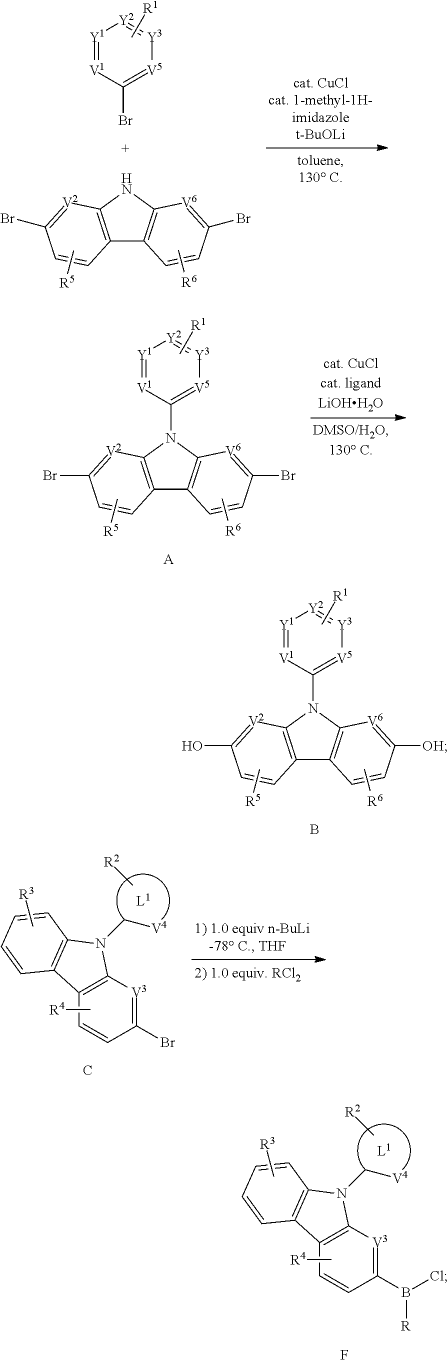

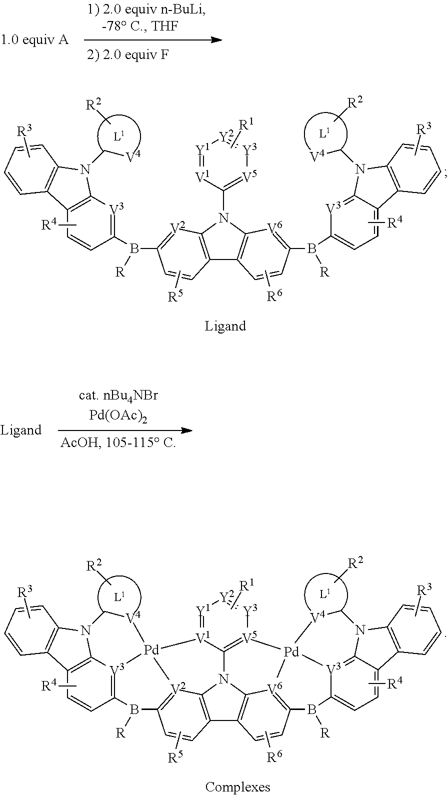

### SYNTHESIS EXAMPLE 1

### Compound I Can be Synthesized as Follows

Step 1:

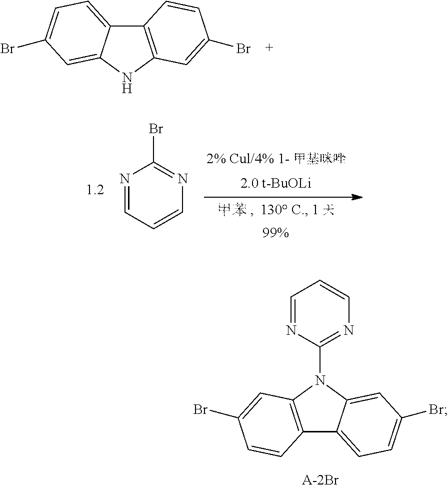

2,7-dibromocarbazolium (1.66 g, 5.10 mmol, 1.0 equivalent), 2-bromopyrimidine (0.97 g, 6.10 mmol, 1.2 equivalent), cuprous iodide (19.4 mg, 0.10 mmol, 0.02 equivalent), Tert-butanol lithium butanol (0.82 g, 10.2 mmol, 2.0 mg/L) are added to the dry three-necked flask with a reflux condenser tube and a magnetic rotor in turn, and the nitrogen is pumped and exchanged for three times, then 1-methyl imidazolium (16.0 UL, 0.20 mmol, 0.04 equivalent) and toluene (20 mL) are added. The reaction mixture is agitated and refluxed at 130° C. for 1 day, and TLC thin layer chromatography is used to monitor the reaction of raw material 2,7-dibromocarbazole. Saturated sodium sulfite solution is quenched, filtrated, and ethyl acetate is used for washing insoluble sufficiently, and the organic phase is separated from the mother liquid, and anhydrous sodium sulfate is dried, filtrated, and the solvent is removed by vacuum distillation. The crude product is selected and purified by silica gel column chromatography. The eluant (petroleum ether/dichloromethane=5:1-3:2) is obtained. The white solid of A-2Br obtained is 2.03 g, with the yield of 99%. mp: 213.5-214.1° C. ¹H NMR (500 MHz, DMSO-d₆): δ 7.47 (t, J=4.5 Hz, 1H), 7.58 (dd, J=8.5, 1.5 Hz, 2H), 8.22 (d, J=3.0 Hz, 2H), 9.02 (d, J=1.5 Hz, 2H), 9.05 (d, J=5.0 Hz, 2H). ¹³C NMR (100 MHz, CDCl₃): δ 116.66, 119.75, 120.47, 120.59, 124.00, 125.80, 139.81, 158.02, 158.60. HRMS (EI): calcd for C₁₆H₉N₃Br₂ [M]⁺ 400.9163, found 400.9178.

Step 2:

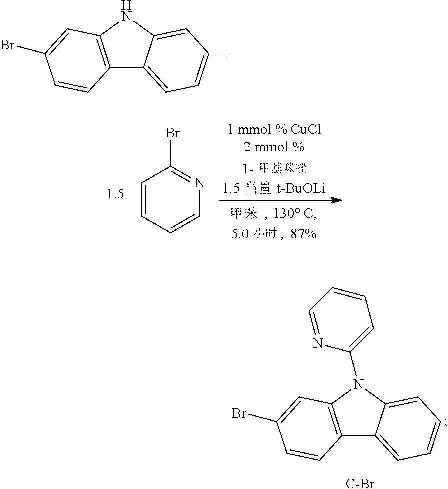

2-bromocarbazolium (14.77 g, 60.00 mmol, 1.0 eq), cuprous chloride (60.0 mg, 0.60 mmol, 0.01 eqg), lithium tort-butanol (7.21 g, 90.00 mmol, 1.5 eq) are added to dry three-necked flask with reflux condensing tube and magnetic rotor in turn. The nitrogen is pumped and exchanged for three times, then 2-bromopyridine (8.58 mL, 90.00 mmol/L. 1.5 eq), 1-methylimidazolium (95.1 ul. 1.20 mmol, 0.02 eq) and toluene (240 mL) are added. The reaction mixture is stirred and refluxed at 130° C. for 5.0 hours. 100 mL saturated sodium sulfite solution is quenched, filtered, and ethyl acetate is used for fully washing insoluble substance, and the organic phase is separated from the mother liquid, and the water phase is extracted by 100 mL, and ethyl acetate is extracted for 3 times, combined with organic phase. It is washed with 50 mL water, filtered, dried with anhydrous sodium sulfate, and the solvent is removed by vacuum distillation. The crude product is selected and purified by recrystallization (petroleum ether: dichloromethane=40 mL:5 mL), and the white solid is obtained with a yield of 87%. ¹H NMR (500 MHz, CDCl₃): δ 7.31-7.34 (m, 2H), 7.42 (dd, J=8.0, 1.5 Hz, 1H), 7.44-7.47 (m, 1H), 7.61 (d, J=8.5 Hz, 1H), 7.77 (d, J=8.0 Hz, 1H), 7.93-7.96 (m, 2H), 8.01 (d, J=1.5 Hz, 1H), 8.08 (d, J=7.5 Hz, 1H), 8.73 (d, J=5.0, 1.5 Hz, 1H).

Step 3:

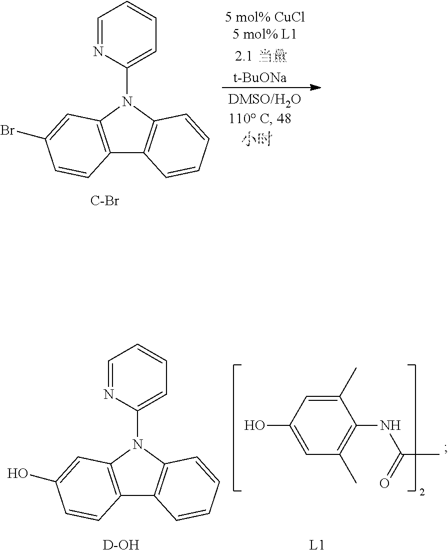

2-bromo-9-pyridyl) carbazole C—Br (9.70 g, 30.00 mmol, 1.0 eq), cuprous chloride (148.5 mg, 1.50 mmol, 0.05 eq), ligand N¹,N²-bis (4-hydroxyl-2. 6-xylene group) oxalamide L1 (493.0 mg, 1.50 mmol, 0.05 eq), sodium tert butanol (6.05 g, 63.0 mmol, 2.1 eq) are added to the drying three-necked flask with magnetic rotor, and the nitrogen is pumped and exchanged for three times, then DMSO (37.5 mL) and deionized water (9.5 mL) are added. The reaction mixture is refluxed at 110° C. for 48 hours, TLC thin-layer chromatography is used to monitor 2-bromo-9-(2-pyridyl) carbazole. After cooling, 100 mL ethyl acetate and 100 mL water is added for dilution, diatomite is added for pumping and filtration, and the ethyl acetate is used for washing insoluble substance sufficiently, and the organic phase is separated and water phase (100 mL×5) is extracted with ethyl acetate, combined with organic phase, add 50 mL water is added to wash organic phase, filter and dry with anhydrous sodium sulfate, and the solvent is removed by vacuum distillation. The mixture ether is recrystallized with ethyl 10 mL acetate and 10 mL petroleum, in order to obtain 5.77 g gray solid. The solvent was removed by vacuum distillation of recrystallized mother liquid. The crude product is separated and purified by silica gel column chromatography. The eluent (petroleum ether/ethyl acetate=3:1) is used to obtain 1.50 g gray solid. The total amount of solid is 7.27 g, with the yield of 93%. ¹H NMR (500 MHz, DMSO-d₆): δ 6.79 (dd, J=8.5, 2.0 Hz, 1H), 7.18 (d, J=2.0 Hz, 1H), 7.23-7.26 (m, 1H), 7.32 (td, J=8.5, 1.0 Hz, 1H), 7.47 (ddd, J=7.5, 5.0, 1.0 Hz, 1H), 7.69 (d, J=8.0 Hz, 1H), 7.74 (d, J=8.0 Hz, 1H), 7.99 (d, J=8.5 Hz, 1H), 8.06 (d, J=7.5 Hz, 1H), 8.11 (td, J=8.0, 2.0 Hz, 1H), 8.72 (ddd, J=5.0, 2.0, 0.5 Hz, 1H), 9.61 (s, 1H). ¹³C NMR (126 MHz, DMSO-d₆): δ 97.10, 110.34, 110.77, 115.85, 119.01, 119.12, 120.78, 121.08, 121.80, 124.02, 124.48, 138.79, 139.29, 140.54, 149.45, 150.88, 157.02. HRMS (ESI): calcd for C₁₇H₁₃N₂O [M+H]⁺ 261.1022, found 261.1028.

Step 4:

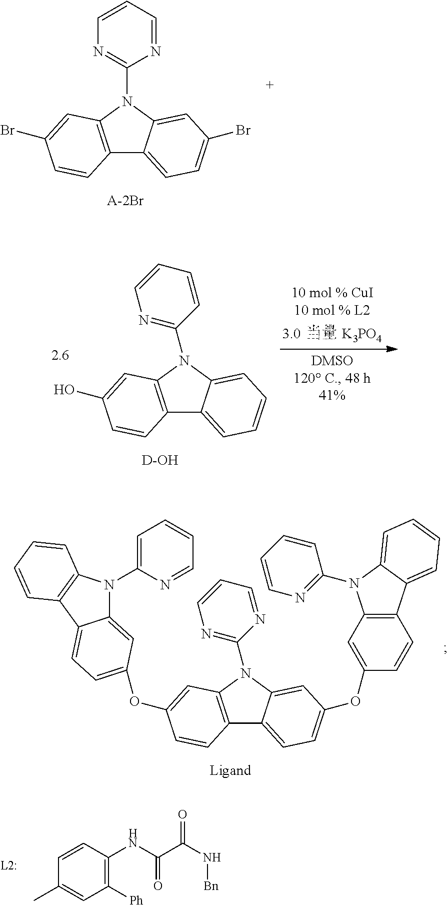

2,7-dibromo-9-(2-pyrimidinyl) carbazole A-2Br (100.0 mg,0.25 mmol, 1.0 eq), 2-hydroxy-9-(2-pyridyl) carbazole D-2OH (169.19 mg, 0.65 mmol, 2.6 eq), cuprous iodide (4.76 mg, 0.03 mmol, 0.10 eq), ligand L2 (8.61 mg, 0.03 mmol, 0.10 eq), potassium phosphate (159.20 mg, 0.75 mmol, 3.0 eq) are added to the drying three-necked flask with magnetic rotor in turn, and the nitrogen is pumped and exchanged for three times, and then DMSO (1.0 mL) is added. The reaction mixture is stirred at 120° C. for 48 hours and TLC thin-layer chromatography is used to monitor 2,7-dibromo-9-(2-pyrimidinyl) carbazole to complete the reaction. After cooling, 30 mL ethyl acetate and 30 mL water are added, it is extracted and filtered by diatomite, and the ethyl acetate is used for washing for 3 times, the organic phase was separated, and the aqueous phase is extracted by ethyl acetate at (20 mL×2), combined with organic phase. It is dried with anhydrous sodium sulfate, filtered, and the solvent is removed by vacuum distillation. The crude product is separated and purified by silica gel column chromatography. The eluent (petroleum ether/ethyl acetate=4:1-1:1) is used to obtain 78.3 mg white solid, with 41% yield. ¹H NMR (500 MHz, CDCl₃): δ 7.02 (t, J=5.0 Hz, 1H), 7.07 (dd, J=7.5, 2.5 Hz, 2H), 7.09 (dd, J=7.5, 2.5 Hz, 2H), 7.24-7.27 (m, 2H), 7.30-7.33 (m, 2H), 7.39-7.43 (m, 2H), 7.60 (d, J=2.0 Hz, 2H), 7.62 (td, J=8.0, 1.0 Hz, 2H), 7.82 (d, J=8.0 Hz, 2H), 7.85-7.88 (m, 2H), 7.92 (d, J=8.5 Hz, 2H), 8.04-8.07 (m, 4H), 8.65 (d, J=2.5 Hz, 2H), 8.66 (ddd, J=5.0, 2.0, 1.0 Hz, 2H), 8.68 (d, J=5.0 Hz, 2H).

Step 5:

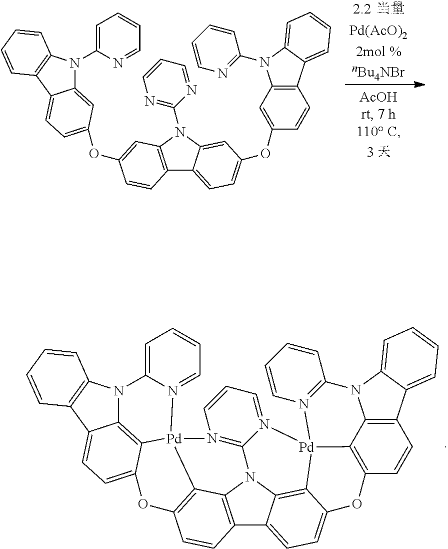

The ligand (200 mg, 0.26 mmol, 1.0 eq), Pd(AcO)₂(128.0 mg, 0.57 mmol, 2.2 eq) and ⁿBu4NBr (20 mg, 0.06 mmol, 0.2 eq) obtained from above steps are added to the flask with magnetic rotor. The nitrogen is pumped and exchanged for three times, and then the solvent acetic acid (32 mL) is added. The reaction mixture is stirred at room temperature for 7 hours and then stirred at 110° C. for 3 days. The reaction mixture is cooled to room temperature and the solvent is removed by vacuum distillation. The crude product is separated and purified by silica gel column chromatography. The eluent (petroleum ether/dichloromethane=1:3-0:1) is used to obtain yellow solid 176.4 mg, with 70% yield. ¹H NMR (500 MHz, DMSO-d₆): δ 7.21 (t, J=5.5 Hz, 1H), 7.23 (d, J=8.0 Hz, 2H), 7.32 (d, J=8.0 Hz, 2H), 7.39-7.43 (m, 4H), 7.48-7.51 (m, 2H), 7.93 (d, J=8.0 Hz, 2H), 8.01 (d, J=8.5 Hz, 2H), 8.07 (d, J=8.0 Hz, 2H), 8.12-8.21 (m, 6H), 8.79 (dd, J=5.5, 1.0 Hz, 2H), 9.36 (d, J=5.0 Hz, 2H).

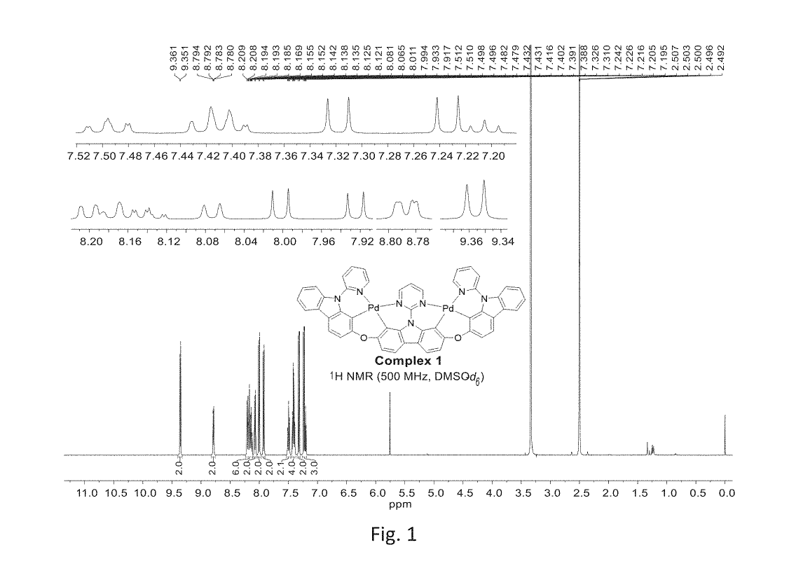

¹H NMR spectra of Compound 1 in DMSO-d₆ is shown in FIG. 1. The analysis on emission spectra of Compound 1 shows obvious luminescence peak.

The binuclear organometallic complexes of the embodiment of the present invention are adapted to various organic electronic components, e.g.: optical and optoelectronic devices, including, but not limited to organic light emitting diodes (OLED), light emitting diodes (LED), compact fluorescent lamps (CFL), incandescent Lampes, organic photovoltaic cells (OPV), organic field effect transistors (OFET) or luminescent electrochemical cell (LEEC).

In addition, the binuclear organometallic complexes of the embodiment of the invention can also be used as biomarkers or imaging techniques.

Binuclear organometallic complexes of the embodiment of the present invention may be used in lighting devices, e.g.: organic luminescent devices, in order to provide better efficiency and/or service life than traditional materials.

The binuclear organometallic complexes of the embodiment of the invention are used as phosphorescent materials and delayed fluorescent luminescent materials, and can be used in organic light-emitting diodes (OLED), light-emitting devices, displays and other light-emitting devices.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A binuclear organometallic complex selected from at least one of the compounds from general formula I: 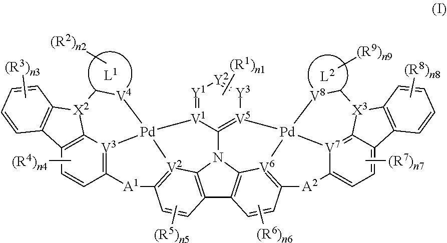
where, L¹ and L² denote C₆˜C₁₈ aromatic ring, C₃˜C₁₈ heterocyclic ring and C₄˜C₈ heterocyclic ring independently, respectively;
V¹, V², V³, V⁴, V⁵, V⁶, V⁷ and V⁸ are selected from nitrogen or carbon atoms independently, respectively, and at least two of V¹, V², V³ and V⁴ are nitrogen atoms, and at least two of V⁵, V⁶, V⁷ and V⁸ are nitrogen atoms;
Y¹, Y² and Y³ are selected from nitrogen or carbon atoms independently, respectively;
A¹ and A² are selected from —O—, —S—, —CH₂—, —CD₂-, —CR^{a}R^{b}—, —C(═O)—, —SiR^{a}R^{b}—, —GeH₂—, —GeR^{a}R^{b}—, —NH—, —NR^{c}—, —PH—, —PR^{c}—, —R^{c}P(═O)—, —AsR^{c}—, —R^{c}As(═O)—, —S(═O)—, —SO₂—, —Se—, —Se(═O)—, —SeO₂—, —BH—, —BR^{c}—, —R^{c}Bi(═O)—, —BiH—, or —BiR^{c}— independently, respectively;
X¹, X², X³ are selected from 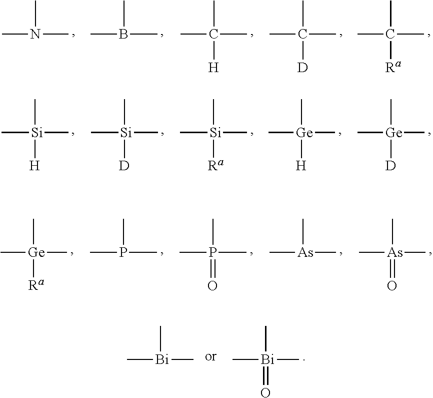
independently, respectively;
R¹, R², R³, R⁴, R⁵, R⁶, R⁷, R⁸, R⁹, R^{a}, R^{b}, R^{c} and R^{d} are selected from hydrogen, deuterium, halogen, hydroxyl, sulfhydryl, nitro, cyanide, amino, carboxyl, sulfonyl, hydrazine, ureyl substituted or unsubstituted C₁˜C₂₄ alkyl, substituted or unsubstituted C₂˜C₂₄ alkyl, substituted or unsubstituted C₂˜C₂₄ alkyl, substituted or unsubstituted C₂˜C₂₄ alkyl, Substituted or unsubstituted C₆˜C₃₆ aryl, substituted or unsubstituted C₃˜C₁₈ heterocyclic, substituted or unsubstituted C₃˜C₃₆ hetero aryl, substituted or unsubstituted C₁˜C₂₄ alkoxy, Substituted or unsubstituted C₁˜C₂₄ alkyl thioyl, substituted or unsubstituted C₂˜C₂₄ epoxy, substituted or unsubstituted C₂˜C₂₄ alkyloxy group, substituted or unsubstituted C₆˜C₃₆ aryl group, Substituted or unsubstituted C₂˜C₂₄ alkoxy carbonyl, substituted or unsubstituted C₂˜C₃₆ ester, substituted or unsubstituted C₂˜C₃₆ amide, substituted or unsubstituted C₁˜C₃₆ sulfonyl group, substituted or unsubstituted C₁˜C₃₆ sulfonyl groups, substituted or unsubstituted C₁˜C₃₆ sulfonyl amines, substituted or unsubstituted C₁˜C₃₆ phosphoryl amines, Substituted or unsubstituted C₂˜C₂₄ alkoxy carbonyl amine, substituted or unsubstituted C₇˜C₃₇ aryl oxy carbonyl amine, substituted or unsubstituted methylsilyl, substituted or unsubstituted C₁˜C₁₈ monoalkylamino, substituted or unsubstituted C₂˜C₃₆ dialkylamino, substituted or unsubstituted C₆˜C₃₆ monoaryl amine, substituted or unsubstituted C₁₂˜C₇₂ bisaryl amine, substituted or unsubstituted C₁˜C₆ suburetic, substituted or unsubstituted C₂˜C₃₆; The substituents are selected from deuterium, halogen, hydroxyl, sulfhydryl, nitro, cyano, amino, carboxyl, sulfonyl, hydrazine, ureyl, C₁˜C₆ alkyl, C₆˜C₁₂ aryl group; two or more adjacent R¹, R², R³, R⁴, R⁵, R⁶, R⁷, R⁸ and R⁹ can be connected into rings;
n₁, n₂, n₃, n₄, n₅, n₆, n₇, n₈ and n₉ are selected from selected from integers of 1˜4 independently, respectively.

2. The binuclear organometallic complex as described in claim 1 selected from at least one of the compounds shown in the general formula IA:

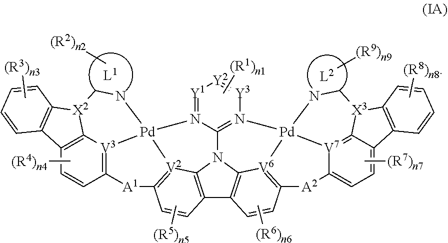

3. The binuclear organometallic complex as described in claim 2 selected from the groups composed of the compounds shown in general formula IAa, general formula, general formula IAc and general formula IAd:

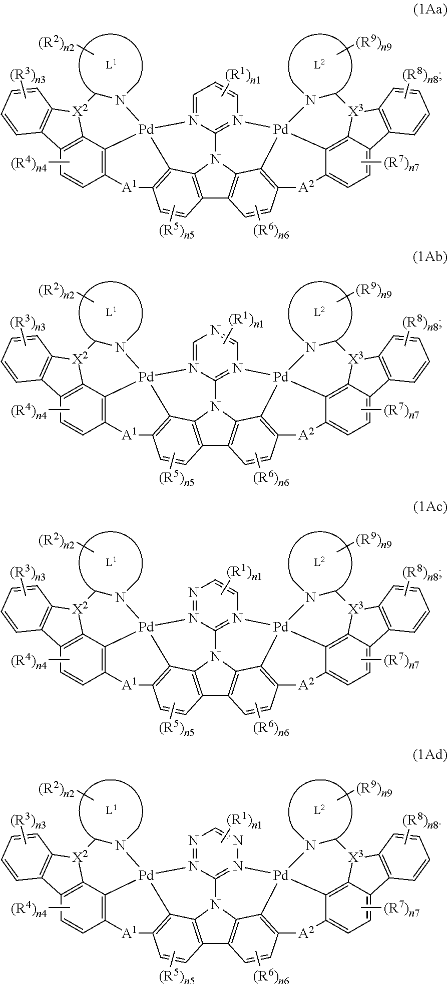

4. The binuclear organometallic complex as described in claim 3, wherein the compounds shown in the general formula IAa are selected from the groups composed of the compounds shown in the general formula IAa1, the general formula IAa2, and the general formula IAa3: 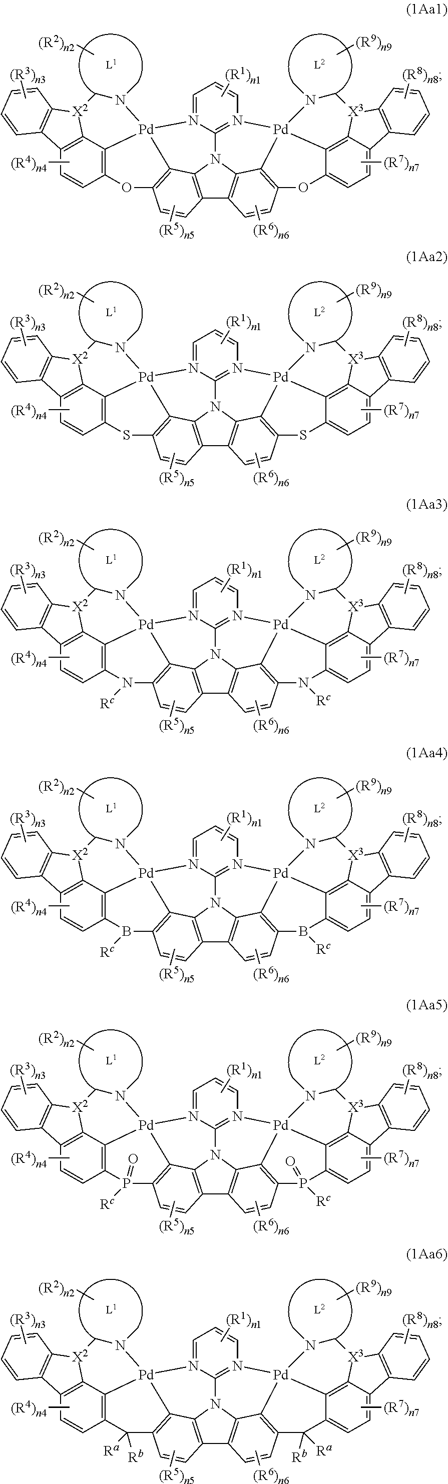
in which, X2 and X3 are selected from 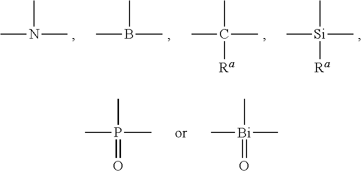
independently, respectively;
R^{a}, R^{b} and R^{c} are selected from substituted or unsubstituted C₁˜C₁₈ alkyl substituted or unsubstituted C₆˜C₃₆ aryl group, substituted or unsubstituted C₃˜C₁₈ heterocyclic group, substituted or unsubstituted C₃˜C₃₆ hetero aryl group and substituents are selected from C₁˜C₆ alkyl and C₆˜C₁₂ aryl groups independently, respectively.

5. The binuclear organometallic complex as described in claim 4, wherein the compounds shown in the general formula IAa3 are selected from the groups composed of the compounds shown in the general formula IAa31, the general formula IAa32, and the general formula IAa33, the compounds shown in the general formula IAa4 are selected from the groups composed of the compounds shown in the general formula IAa41, the general formula IAa42, and the general formula IAa43:

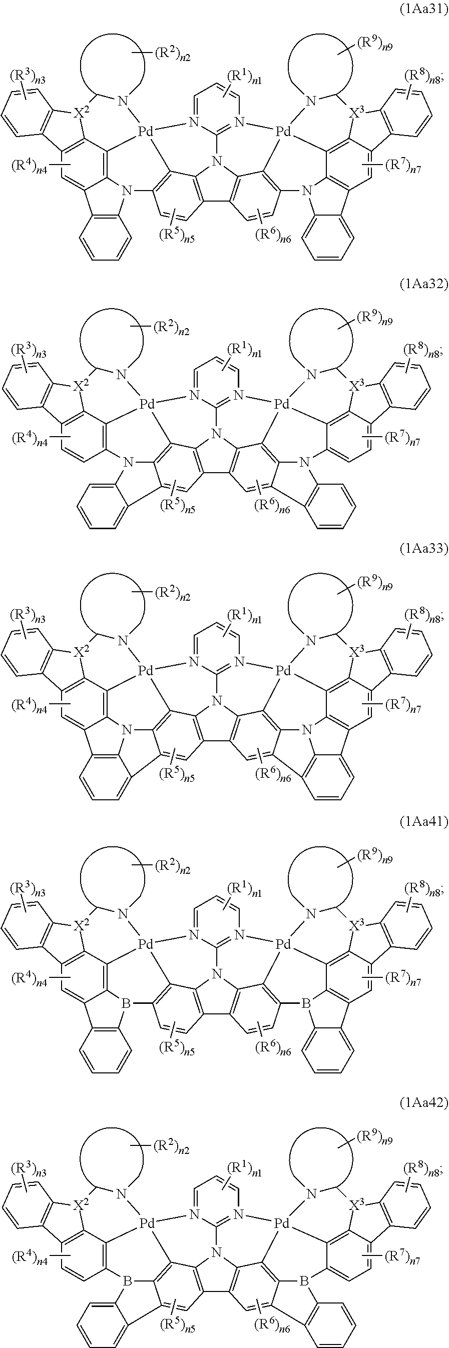

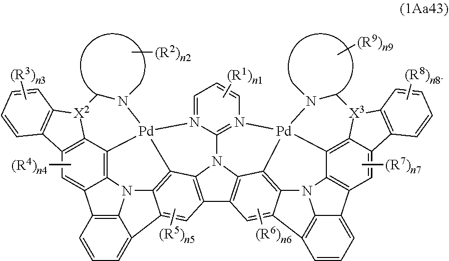

6. The binuclear organometallic complex as described in claim 3, wherein the compounds shown in the general formula IAb are selected from the groups composed of the compounds shown in the general formula IAb1, the general formula IAb2, and the general formula IAb3: 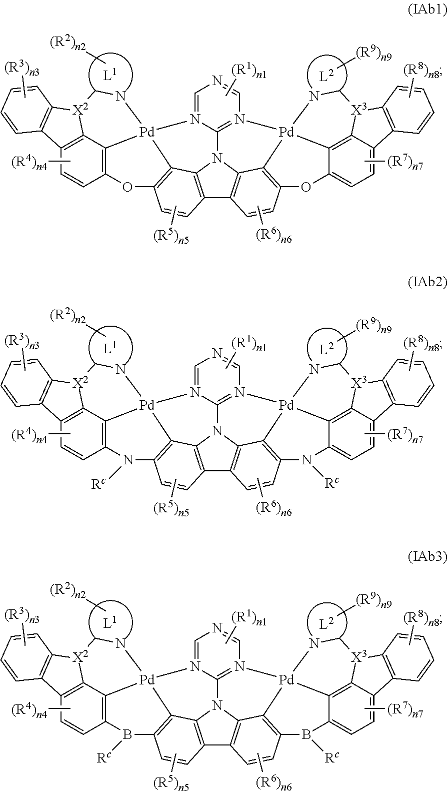
X² and X³ are selected from 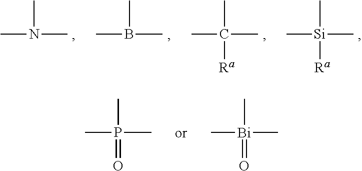
independently, respectively;
R^{a}, R^{b} and R^{c} are selected from substituted or unsubstituted C₁˜C₁₈ alkyl, substituted or unsubstituted C₆˜C₃₆ aryl group, substituted or unsubstituted C₃˜C₁₈ heterocyclic group, substituted or unsubstituted C₃˜C₃₆ hetero aryl group and substituents are selected from C₁˜C₆ alkyl and C₆˜C₁₂ aryl groups independently, respectively.

7. The binuclear organometallic complex as described in claim 6, wherein the compounds shown in the general formula IAb2 are selected from the groups composed of the compounds shown in the general formula IAb21, the general formula IAb22, and the general formula IAb23, the compounds shown in the general formula IAb3 are selected from the groups composed of the general formula IAb31, the general formula IAb32 and the compounds shown in the general formula IAb33;

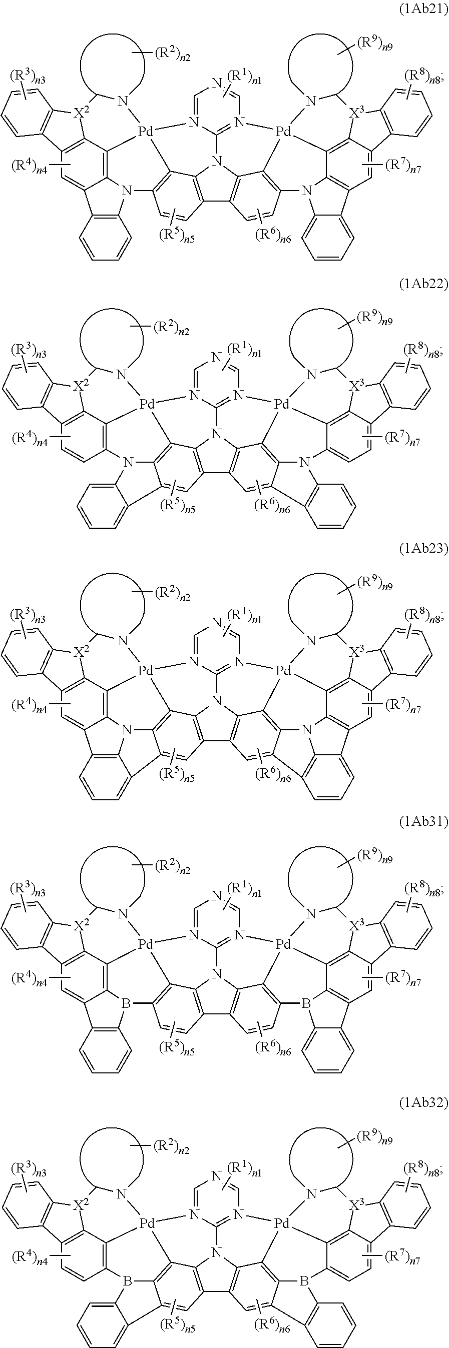

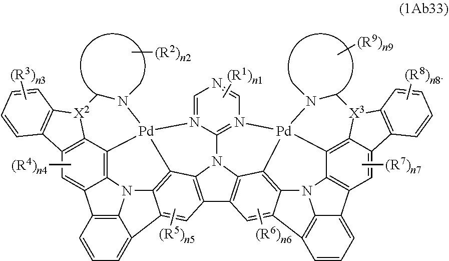

8. The binuclear organometallic complex as described in claim 3, wherein the compound shown in the general formula IAc is selected from at least one of compounds shown in a general formula IAc1, a general formula IAc2, a general formula IAc3: 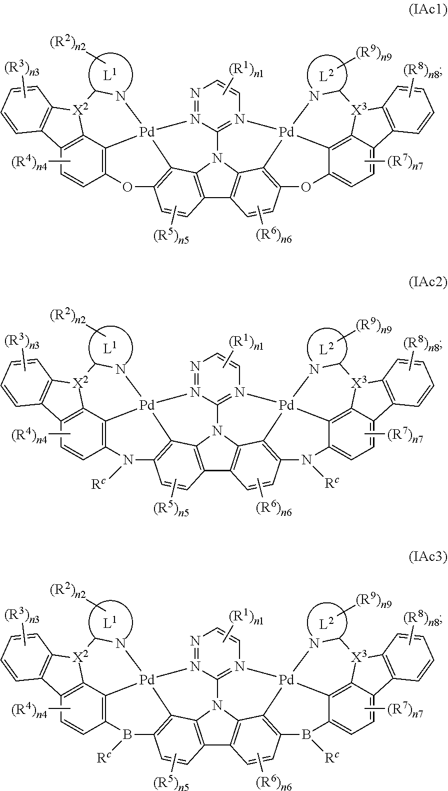
X² and X³ are selected from 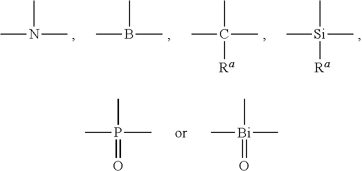
independently, respectively;
R^{c} is selected from substituted or unsubstituted C₁˜C₁₈ alkyl, substituted or unsubstituted C₆˜C₃₆ aryl group, substituted or unsubstituted C₃˜C₁₈ heterocyclic group, substituted or unsubstituted C₃˜C₃₆ hetero aryl group and substituents are selected from C₁˜C₆ alkyl and C₆˜C₁₂ aryl groups independently, respectively.

9. The binuclear organometallic complex as described in claim 8, wherein the compound shown in the general formula IAc2 is selected from at least one of compounds shown in the general formula IAc21, the general formula IAc22, and the general formula IAc23. The compound shown in the general formula IAc3 is selected from at least one of the compounds shown in the general formula IAc31, the general formula IAc32 and the general formula IAc33;

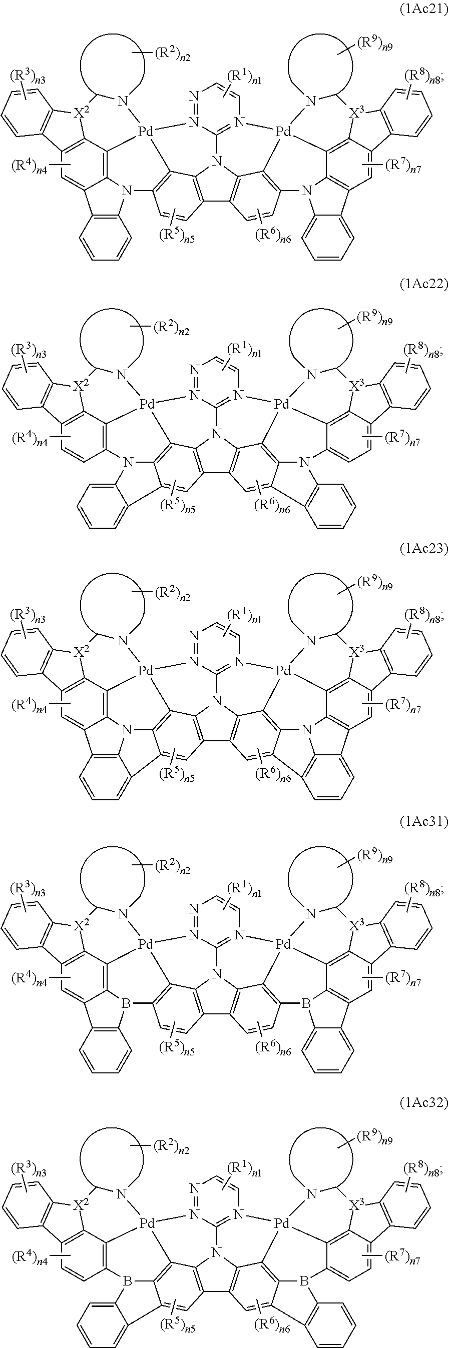

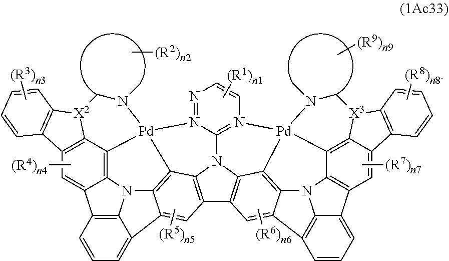

10. The binuclear organometallic complex as described in claim 3, wherein the compounds shown in the general formula IAd are selected from the groups composed of the compounds shown in the general formula IAd1, the general formula IAd2, and the general formula IAd3: 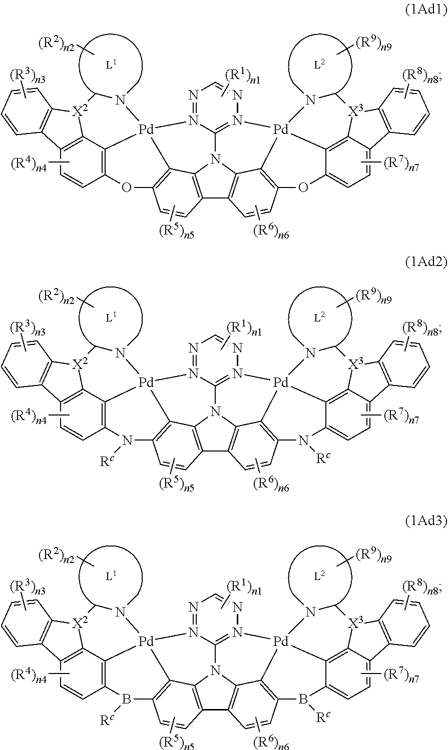
X² and X³ are selected from 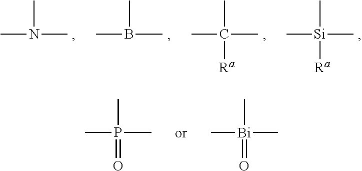
independently, respectively;
R^{c} is selected from substituted or unsubstituted C₁˜C₁₈ alkyl, substituted or unsubstituted C₆˜C₃₆ aryl group, substituted or unsubstituted C₃˜C₁₈ heterocyclic group, substituted or unsubstituted C₃˜C₃₆ hetero aryl group and substituents are selected from C₁˜C₆ alkyl and C₆˜C₁₂ aryl groups.

11. The binuclear organometallic complex as described in claim 10, wherein the compound shown in the general formula IAc2 is selected from at least one of compounds shown in the general formula IAc21, the general formula IAc22, and the general formula IAc23, the compound shown in the general formula IAc3 is selected from at least one of the compounds shown in the general formula IAc31, the general formula IAc32 and the general formula IAc33;

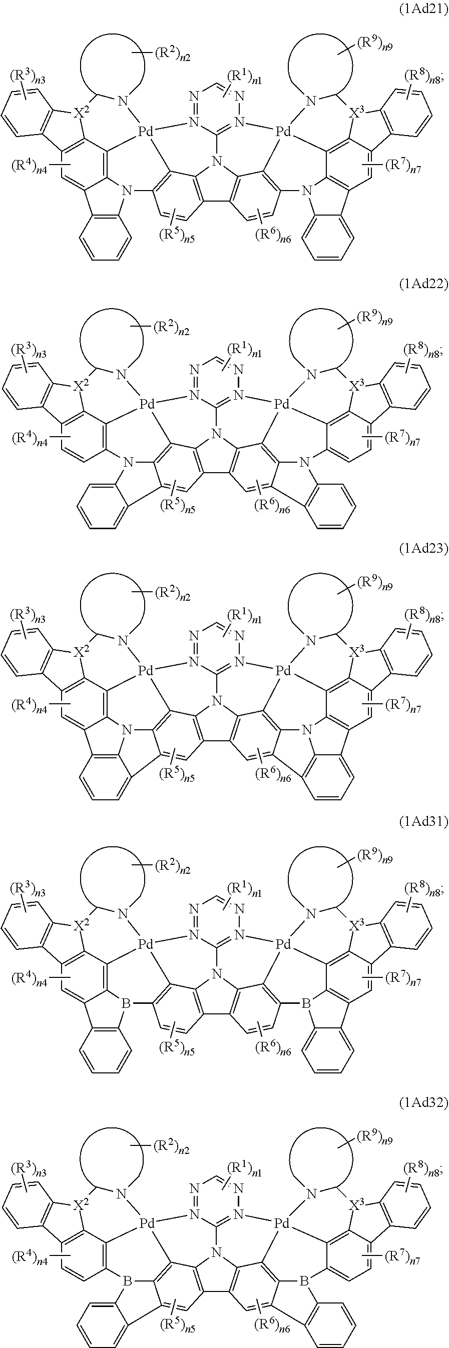

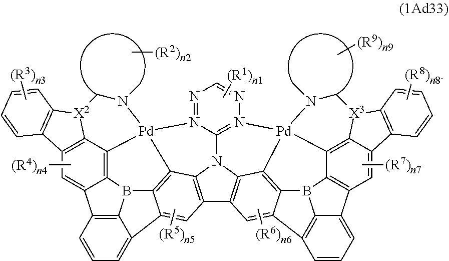

12. The binuclear organometallic complex as described in claim 1, wherein L₁ and L₂ represent the rings denoted in the following structural expressions independently, respectively:

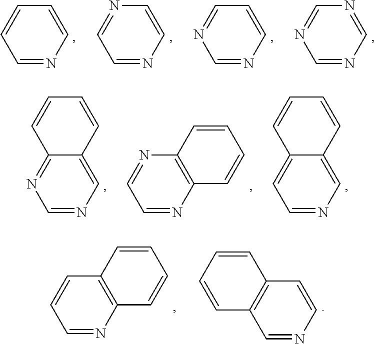

13. The binuclear organometallic complex as described in claim 1 selected from compounds shown in the Compound 1˜compound 246.

14. The binuclear organometallic complex as described in claim 1 being electrically neutral.

15. The binuclear organometallic complex as described in claim 1 applied as phosphorescent or delayed fluorescent materials in an organic electronic assembly.

16. The binuclear organometallic complex described in claim 1 being applied as biomarkers or imaging technique.

17. An application using the binuclear organometallic complex as described in claim 15, wherein the organic electronic components are selected from the organic light-emitting diodes, light-emitting diodes, compact fluorescent lamps, incandescent lamps, organic photovoltaic cells, airfield effect transistors or light-emitting electrochemical cells.
